(19) United States
(12) Patent Application Publication
(10) Pub. No.: US 2026/0352308 A1
(43) Pub. Date: Nov. 5, 2026

(54) BEAM MANAGEMENT AND BEAM INFERENCE

(71) Applicant: InterDigital Patent Holdings, Inc., Wilmington, DE (US)

(72) Inventors: Allan Yingming Tsai, Boonton, NJ (US); Patrick Svedman, Stockholm (SE); Kyle Jung-Lin Pan, Saint James, NY (US); Guodong Zhang, Woodbury, NY (US); Arman Shojaeifard, London (GB)

(73) Assignee: InterDigital Patent Holdings, Inc., Wilmington, DE (US)

(21) Appl. No.: 19/099,940

(22) PCT Filed: Aug. 1, 2023
(86) PCT No.: PCT/US2023/029223

§ 371 Date: Jan. 30, 2025

Related U.S. Application Data
(60) Provisional application No. 63/394,005, filed on Aug. 1, 2022.

(51) Int. Cl. H04B 7/06; H04W 24/10

(52) U.S. Cl. CPC H04B 7/06952; H04W 24/10

(57) ABSTRACT

Described herein are systems, methods and instrumentalities associated with beam management and beam inference (e.g., for holographic MIMO). A wireless transmit/receive unit (WTRU) may receive configuration information from a network device, wherein the configuration information may indicate a hierarchical spatial arrangement of at least a first plurality of beams and a second plurality of beams. The WTRU may be further configured to perform a measurement of a beam that belongs to the first plurality of beams or the second plurality of beams, transmit a report regarding the measurement of the beam to the network device, and determine, based on the configuration information and a beam indication received from the network device subsequent to the transmission of the report, a transmission beam to be used by the WTRU. The WTRU may then perform a transmission using the transmission beam.

### CROSS-REFERENCE TO RELATED APPLICATIONS

This application claims the benefit of Provisional U.S. Patent Application No. 63/394,005, filed Aug. 1, 2022, the disclosure of which is incorporated herein by reference in its entirety.

### BACKGROUND

A wireless communication system may be configured to use multiple input multiple output (MIMO) technologies for transmitting and receiving information in the wireless communication system.

Multiple antenna ports, precoding schemes, and/or CSI feedback mechanisms may be used to facilitate MIMO transmission and reception. Beam management procedures may be implemented to improve beam quality and reduce beam interference.

### SUMMARY

Described herein are systems, methods, and instrumentalities associated with beam management and/or beam inference. A wireless transmit/receive unit (WTRU) as described herein may include a processor that may be configured to receive configuration information from a network device, wherein the configuration information may indicate a hierarchical spatial arrangement of at least a first plurality of beams and a second plurality of beams, the first plurality of beams may be associated with a first spatial resolution, the second plurality of beams may be associated with a second spatial resolution, and an area covered by one of the first plurality of beams may encompass an area covered by one of the second plurality of beams. The WTRU may be further configured to perform a measurement of a beam that belongs to the first plurality of beams or the second plurality of beams, transmit a report regarding the measurement of the beam to the network device, and determine, based on the configuration information and a beam indication received from the network device subsequent to the transmission of the report, a transmission beam to be used by the WTRU. The WTRU may then perform a transmission using the transmission beam.

In examples, the beam measured by the WTRU may be one of the first plurality of beams and the transmission beam may be one of the second plurality of beams. In examples, the WTRU may be further configured to make a prediction about the transmission beam based on the configuration information received from the network device and the measurement performed by the WTRU, and to transmit an indication of the prediction to the network device. For instance, the prediction made by the WTRU may be that the transmission beam to be used by the WTRU is narrower than the beam measured by the WTRU, and the WTRU may be configured to include the indication of the prediction in the report transmitted to the network device.

In examples, the configuration information may include a first codebook associated with the first plurality of beams and a second codebook associated with the second plurality of beams, and the beam indication received from the network device may include an index that may identify the transmission beam in the first codebook or the second codebook. In examples, the configuration information may further indicate a first channel state information reference signal (CSI-RS) resource set associated with the first plurality of beams and a second CSI-RS resource set associated with the second plurality of beams, and the measurement of the beam may be performed using a CSI-RS resource from the first CSI-RS resource set or the second CSI-RS resource set. In examples, the WTRU may be further configured to predict a reception beam based at least on the configuration information received from the network device, and to include an indication of the predicted reception beam in the report transmitted to the network device. The WTRU may, for example, indicate the predicted reception beam via a codeword index associated with a codebook (e.g., the codebook may be included in the configuration information received from the network device and may be associated with the first plurality of beams or the second plurality of beams).

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is a diagram illustrating examples of a hybrid beamforming architecture and antenna ports.

FIG. 3 is a diagram illustrating examples of supported antenna port configurations.

FIG. 4 is a diagram illustrating examples of rotated orthogonal beams and orthogonal discrete Fourier transform (DFT) beams.

FIG. 5 is a diagram illustrating examples of beam management stages.

FIG. 6 is a diagram illustrating an example of spatial domain beam inference based on measurement of a set of wide beams.

FIG. 7 is a diagram illustrating an example of spatial domain beam inference based on measurement of a set of narrow beams.

FIG. 8 is a diagram illustrating an example of a holographic MIMO architecture.

FIGS. 9(a)-9(e) are diagrams illustrating examples of hierarchical beam designs.

FIG. 10 is a diagram illustrating an example of a beam at level k and its sub-beams.

FIG. 11 is a diagram illustrating an example of an SSB beam associate with a low level hierarchical beam in a hierarchical beam structure.

FIG. 12 is a diagram illustrating examples of beam management and beam inference associated with H-MIMO.

FIG. 13 is a flow diagram illustrating an example of beam inference (e.g., when a WTRU is in a radio resource control (RRC) connected state).

FIG. 14 is a diagram illustrating an example of beam management (e.g., at an initial access stage).

FIG. 15 is a diagram illustrating an example of a random access opportunity configuration associated with beam inference.

FIG. 16 is a flow diagram illustrating an example of beam inference at a WTRU (e.g., when the WTRU is in an RRC connected state).

FIG. 17 is a diagram illustrating examples of beam management and beam inference associated with H-MIMO.

FIG. 18 is a diagram illustrating an example a hierarchical beam structure or arrangement that may be configured for a WTRU.

FIG. 19 is a flow diagram illustrating example operations that may be associated with beam management and/or beam inference.

### DETAILED DESCRIPITION

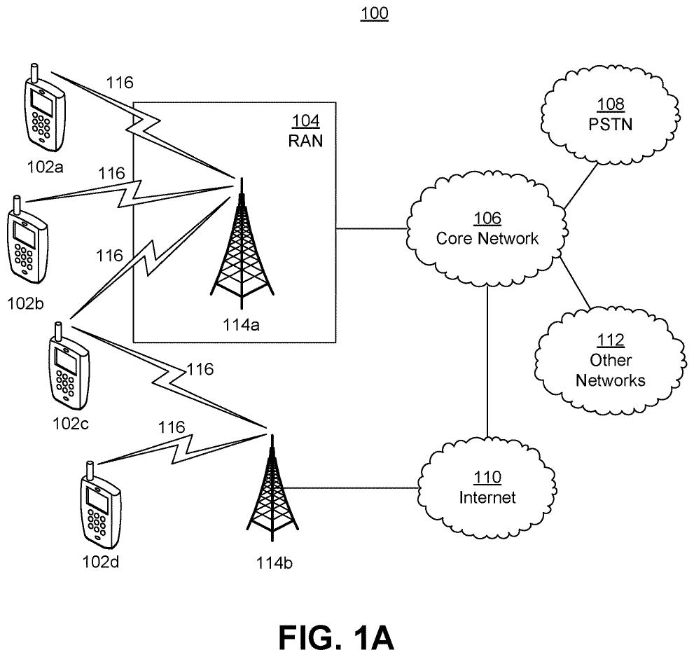

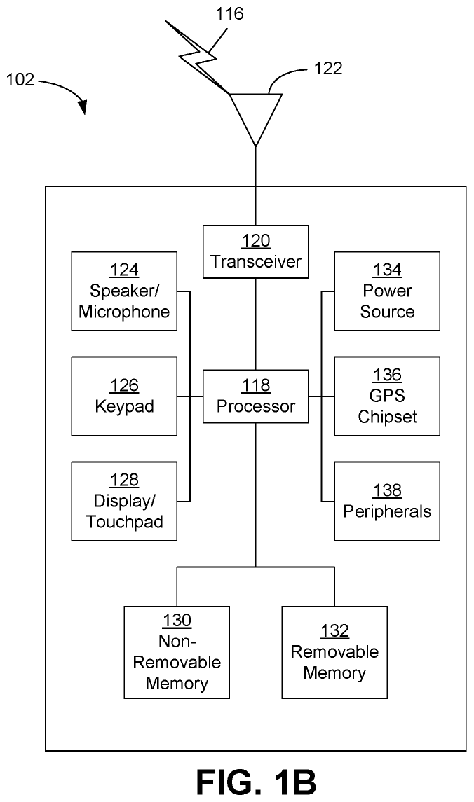

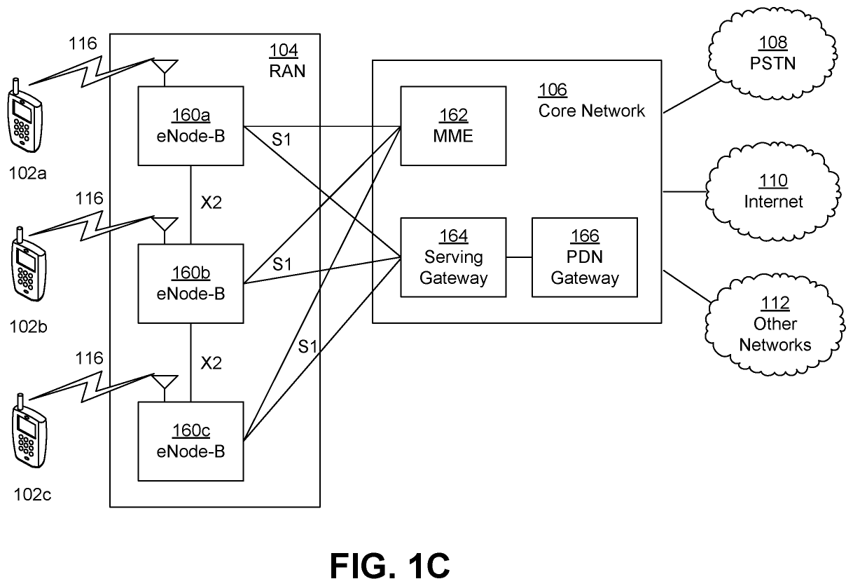

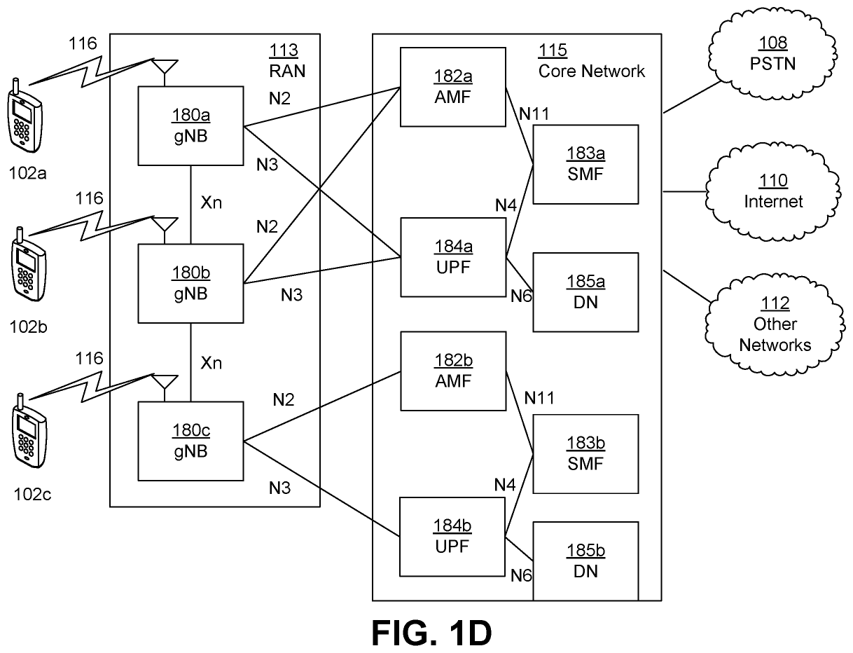

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (WTRU), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c, and 102d may be interchangeably referred to as a WTRU.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B (eNB), a Home Node B, a Home eNode B, a gNode B (base station), a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a base station).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VolP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like.

The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements is depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108.

In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include base stations 180a, 180b, 180c, though it will be appreciated that the RAN 113 may include any number of base stations while remaining consistent with an embodiment. The base stations 180a, 180b, 180c may each include one or more transceivers for communicating with the WTRUs 102a, 102b, 102c over the air interface 116. In one embodiment, the base stations 180a, 180b, 180c may implement MIMO technology. For example, base stations 180a, 108b may utilize beamforming to transmit signals to and/or receive signals from the base stations 180a, 180b, 180c. Thus, the base station 180a, for example, may use multiple antennas to transmit wireless signals to, and/or receive wireless signals from, the WTRU 102a. In an embodiment, the base stations 180a, 180b, 180c may implement carrier aggregation technology. For example, the base station 180a may transmit multiple component carriers to the WTRU 102a (not shown). A subset of these component carriers may be on unlicensed spectrum while the remaining component carriers may be on licensed spectrum. In an embodiment, the base stations 180a, 180b, 180c may implement Coordinated Multi-Point (COMP) technology. For example, WTRU 102a may receive coordinated transmissions from base station 180a and base station 180b (and/or base station 180c).

The WTRUs 102a, 102b, 102c may communicate with base stations 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with base stations 180a, 180b, 180c using subframe or transmission time intervals (TTls) of various or scalable lengths (e.g., containing varying number of OFDM symbols and/or lasting varying lengths of absolute time).

The base stations 180a, 180b, 180c may be configured to communicate with the WTRUs 102a, 102b, 102c in a standalone configuration and/or a non-standalone configuration. In the standalone configuration, WTRUs 102a, 102b, 102c may communicate with base stations 180a, 180b, 180c without also accessing other RANs (e.g., such as eNode-Bs 160a, 160b, 160c). In the standalone configuration, WTRUs 102a, 102b, 102c may utilize one or more of base stations 180a, 180b, 180c as a mobility anchor point. In the standalone configuration, WTRUs 102a, 102b, 102c may communicate with base stations 180a, 180b, 180c using signals in an unlicensed band. In a non-standalone configuration WTRUs 102a, 102b, 102c may communicate with/connect to base stations 180a, 180b, 180c while also communicating with/connecting to another RAN such as eNode-Bs 160a, 160b, 160c. For example, WTRUs 102a, 102b, 102c may implement DC principles to communicate with one or more base stations 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and base stations 180a, 180b, 180c may provide additional coverage and/or throughput for servicing WTRUs 102a, 102b, 102c.

Each of the base stations 180a, 180b, 180c may be associated with a particular cell (not shown) and may be configured to handle radio resource management decisions, handover decisions, scheduling of users in the UL and/or DL, support of network slicing, dual connectivity, interworking between NR and E-WO UTRA, routing of user plane data towards User Plane Function (UPF) 184a, 184b, routing of control plane information towards Access and Mobility Management Function (AMF) 182a, 182b and the like. As shown in FIG. 1D, the base stations 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the base stations 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like.

Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the base stations 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, base station 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

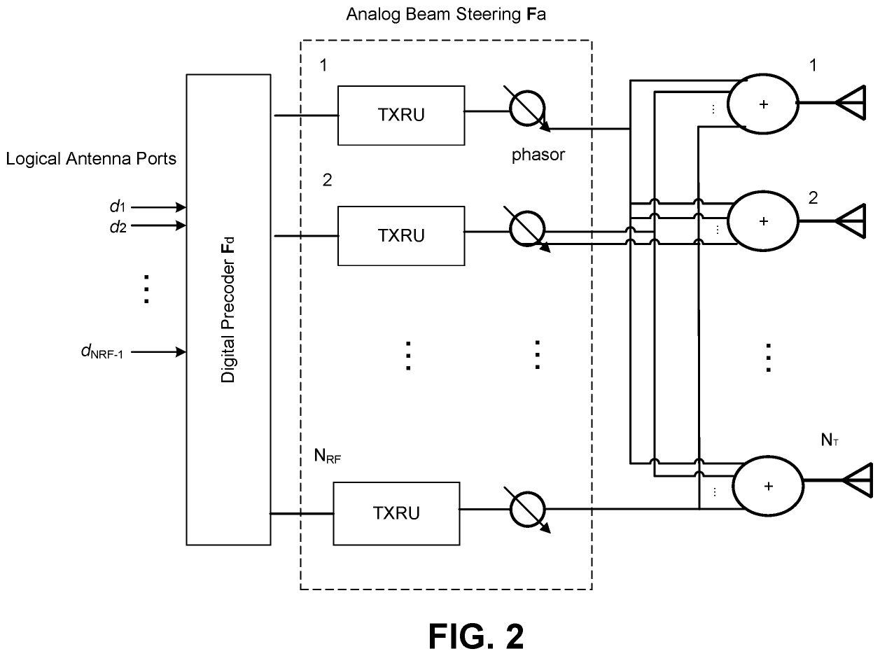

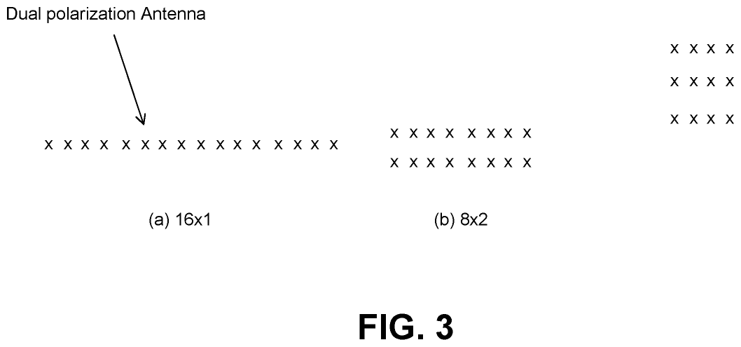

Wireless communication systems may be designed to adapt to different beam-forming architectures and/or deployment scenarios. Hybrid beamforming may be supported. The number of supported antenna port (e.g., logical antenna ports), P, may vary (e.g., having 4, 8, 16, or 32 ports), as illustrated in FIG. 2. The number of antenna ports (e.g., logical antenna ports) may be mapped to different antenna port configurations (e.g., (N₁, N₂) in a panel). For example, assuming dual polarization and/or that the number of dual polarized CSI-RS ports P is equal to 2N₁N₂, 32 ports may be mapped to antenna configurations with (N₁, N₂)=(16,1), (8,2), or (4,4), as shown in FIG. 3.

Downlink (DL) transmissions in a wireless communication system may be performed based on one or more precoding schemes (e.g., non-codebook-based precoding schemes). A precoder may be defined. A precoder matrix indicator (PMI) may be determined and/or used by a WTRU to estimate channel state information (CSI). Multiple (e.g., two) types of precoders may be supported including, e.g., a first type associated with Type-I CSI and a second type associated with Type-Il CSI. Type-I CSI (e.g., which may be associated with a standard resolution) may be optimized for single user MIMO (SU-MIMO) transmissions with a potentially large (e.g., up to 8) number of layers. Type-II CSI (e.g., which may be associated with a high resolution) may be optimized for multi-user MIMO (MU-MIMO) transmissions, with multiple (e.g., up to 2) layers per scheduled WTRU, and/or an overall maximum number of layers (e.g., 12 layers). Type I and/or Type II codebooks may be constructed from a two-dimension (2D) DFT based grid of beams. Type I and/or Type II codebooks may enable CSI feedback of beam selection and/or phase shift keying (PSK) based co-phase combining between two polarizations. Type II codebook-based CSI feedback reports may include the wideband and/or subband amplitude information of one or more selected beams.

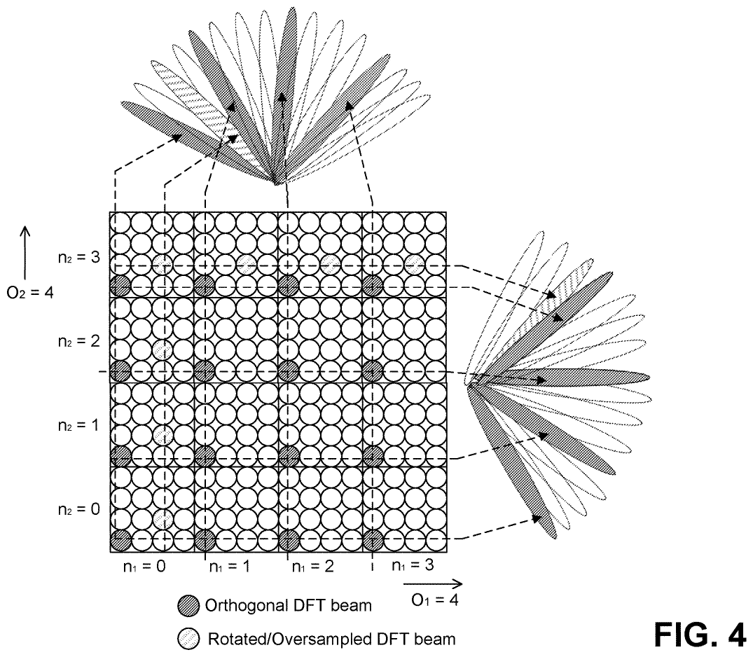

The number of beams in a grid of beams (GoB) may be dependent on (N₁, N₂) and (O₁, O₂), where (O₁, O₂) may represent an oversampling factor or rotated factor in a Type I or Type II codebook. A rotated beam may be equivalent to an oversampled DFT beam with oversampling factors O₁ and O₂. For hdexample, for (N=4, N2=4) and (O₁=4, O₂=4), a total of 256 beams in a GoB may be formed including 16 orthogonal DFT beams and 240 (e.g., 256-16) rotated beams, as shown in FIG. 4. The rotated beams may be non-orthogonal. The beam width may be dependent on (N₁, N₂). The functionality of (O₁, O₂) may be applied (e.g., used) during a beam management or beam tracking procedure (e.g., during one or more beam sweeping steps of the beam management or beam tracking procedure.

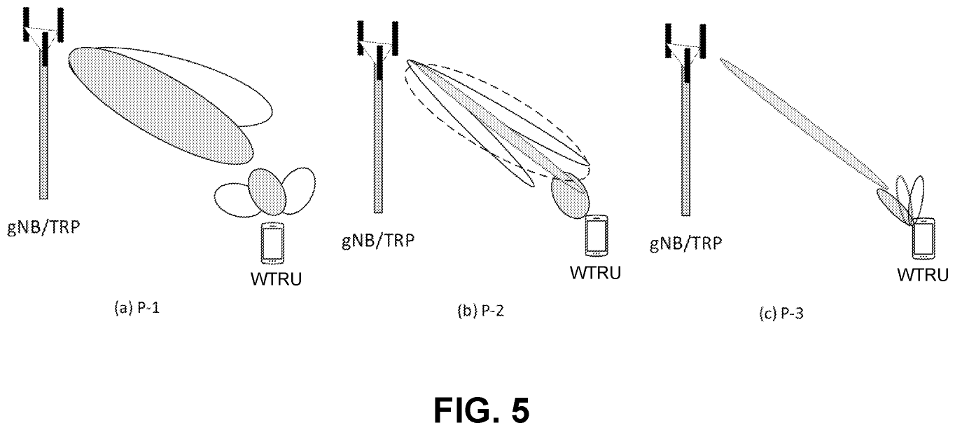

Downlink (DL) beam management (BM) may aim at adjusting one or more transmission (Tx) beams of a transmission and reception point (TRP) and/or one or more reception (e.g., Rx) beams of a WTRU. A DL beam management procedure may be performed in multiple steps (e.g., three steps) such as P-1, P-2, and P-3 shown in FIG. 5. For example, at P-1, a WTRU may measure one or more TRP Tx beams to facilitate (e.g., support) the selection of a TRP Tx beam and/or a WTRU Rx beam. Wide beam scanning may be applied at this step to determine an optimal Rx beam, and the WTRU may select a suitable wide beam (e.g., based on a synchronization signal block (SSB)) for UL transmission based on the measurements. At P-2, the WTRU may measure one or more additional TRP Tx beams in order to refine (e.g., change) an inter-TRP or intra-TRP Tx beam. For example, a base station (e.g., a gNB) may configure the WTRU with one or more CSI-RS resource sets, where each CSI-RS resource set may include multiple CSI-RS resources that the WTRU may use (e.g., during CSI measurement and/or reporting) for beam refinement (e.g., to select a refined or narrow beam). The gNB may determine a narrow beam for downlink transmission and/or uplink reception based on measurements (e.g., downlink measurements) performed by the WTRU on one or more candidate beams (e.g., refined or narrow Tx beams). At P-3, the WTRU may measure the same TRP Tx beam to determine (e.g., change) a Rx beam of the WTRU (e.g., if the WTRU is configured for beamforming). The WTRU may also determine a Tx beam for uplink transmissions based on downlink measurements of one or more Rx beams of the WTRU. In this step, the gNB may repeat one or more beams (e.g., narrow beams) for the WTRU to perform the measurements.

Beam management may be performed based on a hierarchical beam searching principle. For example, a WTRU may (e.g., first) select a wide beam from a set of candidate wide beams (e.g., based on one or more SSBs) and may feedback (e.g., report) the selected beam (e.g., a corresponding SSB) to the network, for example, via a physical random access channel (PRACH) in an initial access stage. The network (e.g., a network device such as a base station) may, in response to receiving the feedback, transmit multiple refined narrow beams based on the wide beam (e.g., SSB) selected by the WTRU (e.g., the refined narrow beams may provide initial spatial information to the WTRU). The refined narrow beams may be associated with corresponding CSI measurement and/or reporting configurations, which may be used by the WTRU to determine a refined narrow beam and report the determination to the network.

One or more beam tracking techniques may be employed to ensure that a suitable (e.g., best) beam pair for data transmission/reception is maintained if a WTRU moves or if the WTRU's operating environment changes. A base station may (e.g., periodically) broadcast SSBs, from which the WTRU may determine the strength of one or more beams (e.g., indicated by corresponding RSRP values) by measuring the SSBs. The WTRU may report the determined (e.g., measured) beam strength values to the base station, which may decide a suitable (e.g., best) transmission beam for the WTRU. The beam tracking techniques described herein may be used for wide and/or narrow beam selection and changes. The beam tracking techniques may be used to detect the strongest narrow beam based on WTRU measurements of CSI reference signals (CSI-RSs) and/or SSBs.

A WTRU may use one or more CSI reference signals to estimate a channel and/or send a report to a base station (e.g., gNB) about the estimation. For example, the WTRU may measure a DL CSI-RS and may report the measurement via one or more uplink (UL) messages. The measurement may be used by the base station for mobility check and/or beam management. Multiple (e.g., three) types of CSI reporting may be supported including, for example, periodic reporting, semi-persistent reporting, and aperiodic CSI reporting. Periodic CSI reports may be configured by the network to be generated and transmitted with a certain periodicity. For example, periodic CSI-RS transmissions may be configured such that they may occur once every M-th time slots (e.g., based on a parameter such as CSI-ResourcePeriodicity AndOffset), where M may range from 4 to 640 time slots. Measurement reporting of these CSI-RS transmissions may be performed via a PUCCH. Semi-persistent CSI reporting may be similar to periodic CSI reporting (e.g., in terms of configuration), with the exception that the activation and deactivation of CSI-RS transmissions for semi-persistent CSI reporting may be controlled by the network (e.g., via a MAC layer transmission such as a MAC CE).

A layer-1 RSRP (L1-RSRP) such as an RI-RSRP and/or an SSB-index-RSRP may be used during beam management or beam tracking to identify a suitable beam (e.g., a best downlink beam). An SSB-Index-RSRP may be measured and/or reported based on an SSB associated with a beam. An CRI-RSRP may be measured and/or reported based on a CSI-RS resource associated with a beam.

Beam management may include beam inference in time and/or spatial domains, for example, for overhead and/or latency reduction, beam selection accuracy, etc. The inference (and/or management) may be performed on the network side, on the WTRU side, or on both sides. Performing beam inference and/or management on the network side may reduce the computational complexity for a WTRU, in which case the WTRU may still provide feedback such as L1-RSRP feedback to the network. There may be overhead associated with such feedback, and techniques such as RSRP compression techniques may be used to reduce the overhead. Performing beam inference and/or management on the WTRU side may reduce or eliminate the forementioned feedback overhead (e.g., because the WTRU may predict and/or indicate a suitable beam via an CSI-RS resource indicator (CRI), and thus not report a measured L1-RSRP), but such an approach may increase the power consumption of the WTRU, for example, due to the computation complexity of the operation.

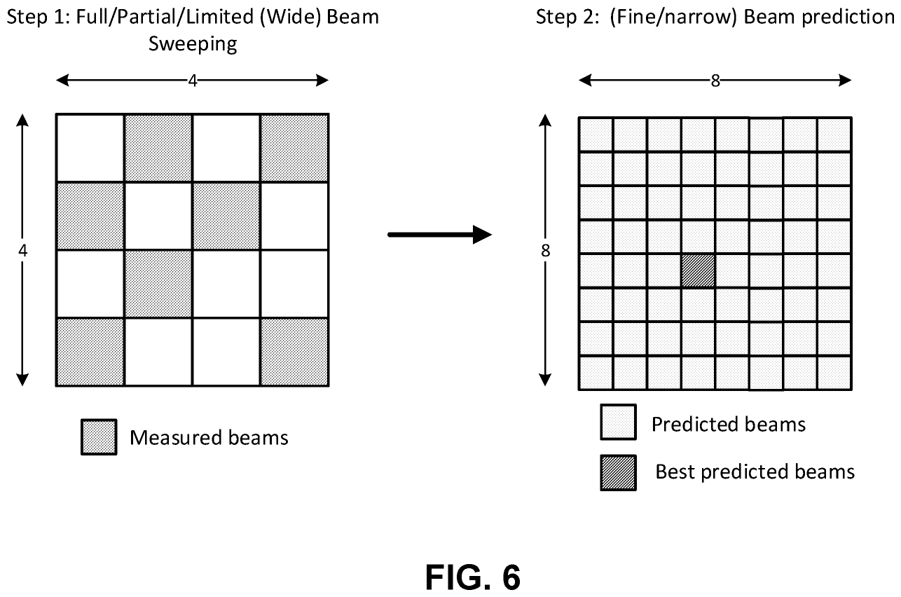

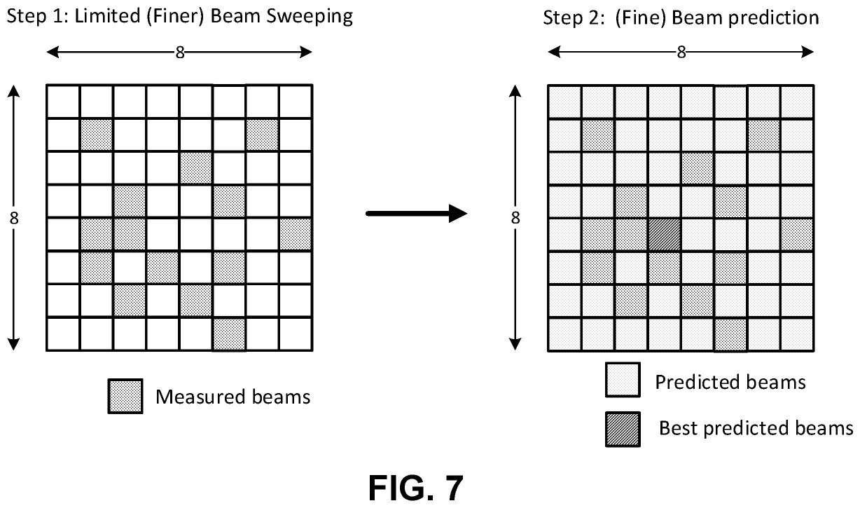

Beam inference and/or management may be analogous (e.g., at least to some degree) to selecting a grid or pixel from a 2D image of beams, wherein the grid (or pixel) of the 2D image may represent a spatial coverage area of the selected beam (e.g., each grid in the 2D image may correspond to a beam and the area of the grid may correspond to the width of the beam such as 3 dB). Multiple approaches may be taken for spatial domain (SD) beam inference. With a first example approach, a suitable (e.g., optimal) beam may be inferred based on measurements of a set or subset of wide beams, as shown in FIG. 6. In this example, a subset of wide beams (e.g., corresponding to SSBs) may be measured and one or more narrow (e.g., fine) grids of beams may be predicted based on the measurement, from which a suitable (e.g., best) beam may be further predicted. Such an approach may be referred to or categorized as a super-resolution approach. With a second example approach, a suitable or optimal beam (e.g., a narrow beam) may be inferred based on measurements of a set or subset of narrow beams, as shown in FIG. 7. In this example, a subset of narrow beams (e.g., corresponding to CSI-RSs) may be transmitted for measurement and the top k beams ranked by measurement results may be predicted as suitable beams. Such an approach may be referred to or categorized as an interpolation or recovery approach (e.g., since the beams are recovered based on partial data or information of the same beam resolution).

A wireless communication system having an infinite number of antennas in a finite space may be referred to as a holographic MIMO (H-MIMO) or large intelligent surfaces (LIS) system. Beam forming may be performed in such an H-MIMO and/or LIS system, and may be referred to herein as holographic beam forming. Holographic beam forming may be performed in a dynamic manner, e.g., using a configurable (e.g., fully configurable) meta-surface that may provide an architecture with lower cost, size, and/or power consumption compared to conventional digital, analog, and/or hybrid architectures. The meta-surface may include thin electromagnetic (EM) materials, which may generate EM rays in an intelligent way (e.g., by configuring an array of phase shift elements and delivering desired EM behaviors in a reconfigurable pattern). This may be different than (e.g., at least in some ways) conventional phased arrays and/or active antenna systems.

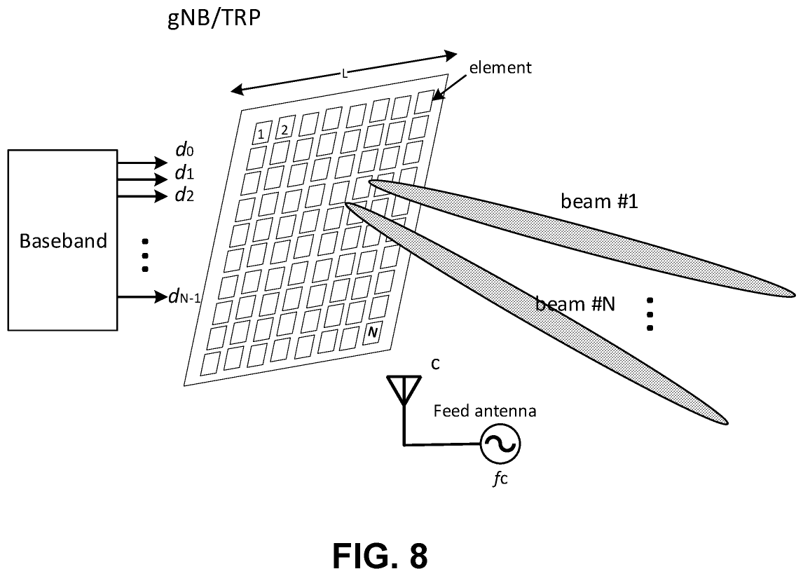

FIG. 8 shows an example of an H-MIMO architecture. As shown, the H-MIMO architecture may include multiple (e.g., three) components such as, e.g., a meta-surface with N radiation elements, a feed antenna that may be configured to transmit a reference signal with a carrier frequency fc, and/or a baseband that may be configured to synthesize the generation of EM rays. If an antenna size or antenna elements become comparable to a link distance, operating conditions may satisfy a Fresnel region, in which near-field propagation may take place. The degree of freedom (DoF) associated with H-MIMO beamforming may be greater than one (e.g., for a line of sight (LoS) channel and/or in near-field conditions). An H-MIMO beamforming framework may be used to enhance the MIMO capacity of an LoS channel.

Beamforming gains in a hybrid beamforming architecture may be constrained by the number of transceiver units (TxRU), which in turn may constrain the number of logical antenna ports. This may be because the beamforming gains may be synthesized from analog and digital beamformers, and it may be difficult for beamforming gains under such a hybrid arrangement to achieve an optimal level. H-MIMO may provide greater beamforming gains than a hybrid beamforming scheme because multiple (e.g., all) antenna elements are configurable. H-MIMO may also allow for translation of a network from a logical domain (e.g., which may comprise antenna ports) into a physical domain (e.g., which may comprise RF ports), for example, by treating the radio environment as a software entity that may be programmed, reconfigured, and/or optimized.

Deployment of ultra massive MIMO may enhance beam quality, mitigate beam interference, and/or increase opportunities of spatial multiple gains. As the number of antenna elements increases, more narrow beams may be formed with better beam quality (e.g., as a result of increased beamforming gains). For example, an H-MIMO system may include 160000 antenna elements with a 1×1 square meter meta-surface, ¼-wavelength antenna separation, and/or a central frequency of 30 GHz. The ultra massive number of antenna elements and/or the capability for generating narrow beams in such an H-MIMO system may affect the way beam management may be performed, since conventional beamforming techniques such as hybrid analog and digital beamforming may no longer be applicable because of network routing and/or hardware limitations. The amount of time spent in beam searching may be proportional to the number of beams (e.g., Tx beams) to be searched and, as such, beam searching may take longer in an H-MIMO system. Larger CSI-RS signaling overhead and/or latency associated with signal monitoring, signal measurement, and/or network responses may also be expected if H-MIMO is deployed.

Techniques such as beam inference may be used to reduce beam searching overhead and/or the time spent for beam management. The performance of a beam inference model such as an artificial intelligence/machine learning (AI/ML) based beam inference model may be dependent on several factors including, for example, the spatial, time, and/or frequency variations of a channel due to WTRU mobility or changes in a relevant environment, beam resolution, and/or the number of beams to be swept. There may be gaps in existing beam inference models that may cause those models to fall short for H-MIMO. For instance, as shown in FIG. 6, the accuracy and/or inference error of beam inference based on partial wide beams (e.g., SSBs), which may be viewed as a low-resolution image (e.g., a 2D image of beams), may be hampered by the limitations of a super-resolution model such as an AI/ML based model. A refined (e.g., narrow) beam may be predicted or inferred (e.g., by a network device) from a subset of measured beams. The predicted beam (e.g., a refined or narrow beam) may not be among a first set of beams or reference signals (RS) measured by a WTRU, or among a subset of the first measured beams or reference signals. As a result, a network device (e.g., a base station) may transmit additional information to the WTRU regarding an inferred or predicted beam (e.g., a refined or narrow beam). For example, the network device may configure and transmit a second set of reference signals or beams for the WTRU to measure and select (e.g., predict) one or more of the beams or reference signals to feed back to the network (e.g., so that the network may determinate which transmission configuration indicator (TCI) state may be activated for a PDCCH or PDSCH transmission). In these situations, if the spatial information of the reference signals or beams is unknown to the WTRU, the WTRU may perform a beam search, which may result in increased computational efforts and/or latency. Since more narrow (e.g., finer) beams may be generated or expected in an H-MIMO system due to a larger number of antenna elements in a finite surface, the likelihood that an predicted or inferred beam (e.g., a refined or narrow beam) may not be among a set or subset of measured beams may be high. This may mean that additional beam searching efforts by a WTRU may be frequent and may increase the overhead and/or latency associated with beam management. Further, as shown in FIG. 2, the number of TxRU in a hybrid beamforming architecture may be limited. The quality of the beams (e.g., as a result of synthesized beamforming and/or precoding based on analog and digital beamforming weights) may also be constrained by the hybrid beamforming architecture. In contrast, antenna elements (e.g., every antenna element) of an H-MIMO system may be programable, so beamforming weights may not be limited by a hybrid or analog beamforming architecture, and beam management performance may be improved by utilizing the programmable property of the elements.

Beam management including beam inference techniques may be used to support H-MIMO, large intelligent surface (LIS), and/or various beamforming architectures such as fully digital, hybrid, and/or analog beamforming architectures. A network device may adopt different beam management (including beam inference) techniques than a WTRU. For example, beam interference at the network device may use different measurement metrics (e.g., L1-RSRP) for feedback reporting and/or other procedures than metrics used by the WTRU. A hierarchical beam indication mechanism (e.g., configuration and/or signaling associated with a hierarchical spatial arrangement of beams) may be implemented so that the network device and the WTRU may exchange beam information (e.g., for different levels of beams or beams with different spatial resolutions). In a first example use case, both the network device and the WTRU may be made aware of beam resolutions and/or quasi-co-location (QCL) information of beams based on a hierarchical beam structure (e.g., a hierarchical spatial arrangement of beams). This use case may apply, for example, if the network device uses wide or narrow beams for beam inference, and the WTRU reports an inferred narrow beam to the network (e.g., when beam inference is enabled at the WTRU side). In a second example use case, the network may use wide or narrow beams for beam inference, and may indicate an inferred beam (e.g., when beam inference is performed at the network side) to the WTRU so that the WTRU may perform a quick beam paring.

A hierarchical reference signal or beam structure (e.g., a hierarchical arrangement of reference signals or beams) may be implemented, where the term “reference signal” and the term “beam” may be used interchangeably in the relevant examples provided herein. For example, one or more sets of hierarchical reference signals (RS's), which may be based on corresponding grids of beams, may be configured or pre-defined in a spatial domain for a WTRU and/or a network, and the network and/or the WTRU may use the pre-defined or configured hierarchical beams for beam mapping, beam indication, beam inference, etc. The hierarchical reference signals or beams may have one or more of the following properties.

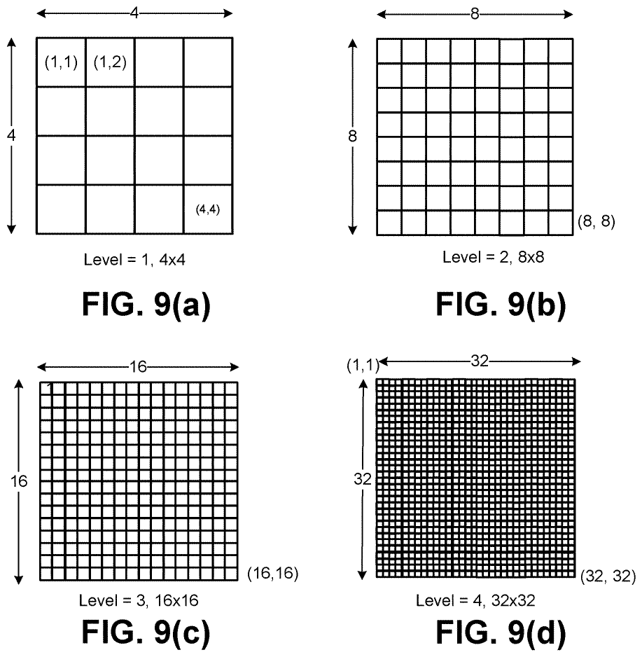

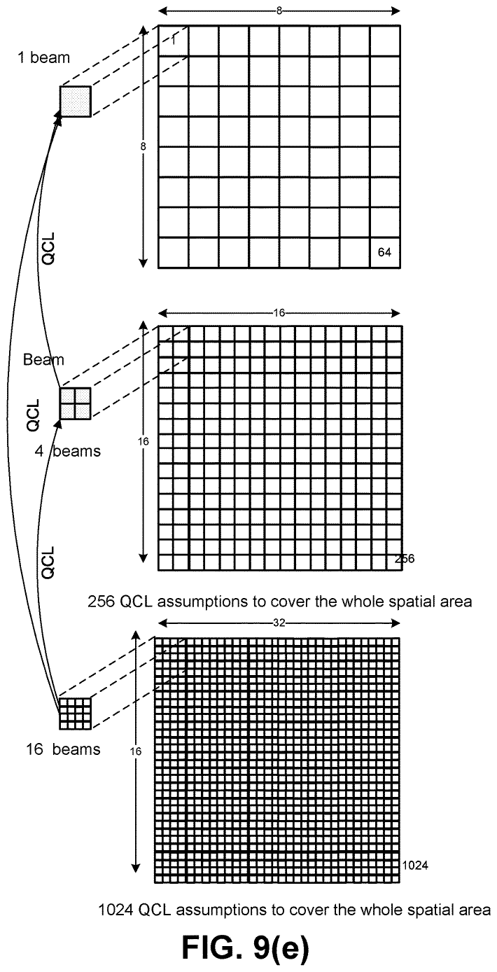

Multiple (e.g., K) different hierarchical levels of reference signals or beams may be configured or defined (e.g., based on a hierarchical spatial arrangement of the beams). For a level k (e.g., 1≤k≤K), m reference signals or beams may be configured or defined (e.g., arranged into a grid of beams). A (e.g., each) reference signal or beam may have its own coverage area (e.g., represented by a square in a 2D-image of the beams, as shown in FIGS. 9(a)-9(e). If a reference signal or beam at level k+1 is within (e.g., encompassed by) a beam coverage of a reference signal or beam at level k (e.g., a square at level k+1 is within a square at level k, as shown in FIG. 9), the reference signal or beam covering a square (e.g., indicative of a beam coverage) at level k+1 has a QCL type D relationship with the reference signal or beam at level k. In other word, the (3dB) beamwidth (or spatial coverage) of a reference signal or beam at level k may cover the reference signal or beam at level k+1 (e.g., the square at level k+1 may be within the square at level k). In terms of QCL assumption, the reference signal or beam at level k may have m (e.g., m=2^{2\hat{ }(k)}) QCLed reference signals or beams at the next level (e.g., at level k+1).

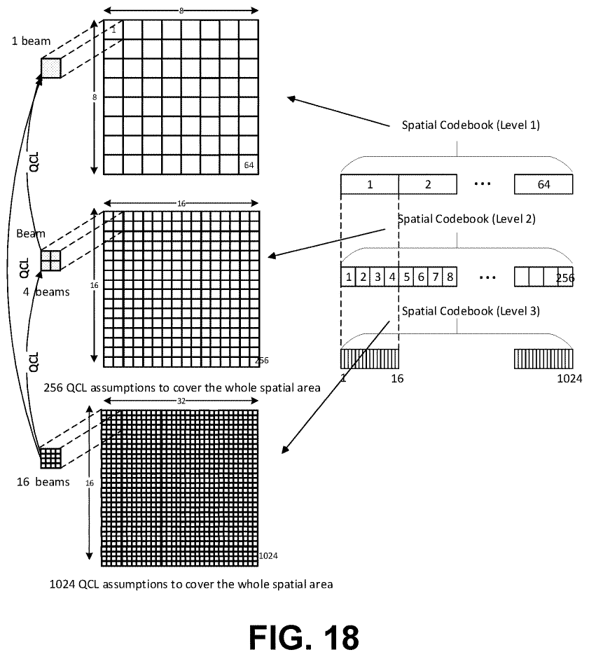

FIGS. 9(a)-9(e)) show examples of hierarchical RS/beam arrangements or designs. In these examples, four levels of hierarchical reference signals or beams may be defined for a spatial domain (SD) (e.g., the definition may indicate a hierarchical spatial arrangement of the reference signals or beams). A lower level of reference signals or beams may have a wider beam width, while a higher level of reference signals or beams may have a narrower beam width. A square in the 2D-image shown in FIG. 9 may represent a beam coverage area (e.g., a 3 dB beam width). At a lower level, the square may have a larger area, which may imply a wider beam width, and the area may become smaller (e.g., the beam width may become narrower) as the level gets higher. The union or combination of the beam coverage areas within a same level may correspond to a specific spatial domain. A reference signal or beam at level k may be configured to encompass m QCLed reference signals or beams at the next level (e.g., level k+1) through a hierarchical spatial arrangement. FIG. 18 shows an example design for a QCL assumption with different levels of reference signals (e.g., CSI-RS) or beams. In the example of FIG. 18, three levels of beams may be used to cover the same spatial area. The first level (e.g., k=1) may include 64 beams (8×8) to cover a spatial region the second level (e.g., k=2) may include 256 beams (16×16) to cover the same spatial region, and the third level (e.g., k=3) may include 1024 beams (32×32) to cover the same spatial region.

The (3 dB) beamwidth of a (e.g., each) beam at the second and/or third level may be QCLed with a beam at the first level. As such, a (e.g., each) beam at the first level (e.g., level k=1) may be QCLed with m=2^{2\hat{ }1}=2²=4 beams at the second level (e.g., level k=2) and with m=2^{2\hat{ }2}=2⁴=16 beams at the third level (e.g., level k=3). Therefore, when a beam at a specific level is specified, one or more beams at the next level may be determined based on a hierarchical QCL relationship.

The reference signals or beams at a (e.g., each) specific level (e.g., level k) can be designed or represented by a codeword in a codebook (e.g., a DFT codebook). For example, configuration information sent by a network device to a WTRU may include multiple codebooks that indicate the hierarchical spatial arrangement of reference signals or beams at different levels (e.g., the different levels may correspond to different spatial resolutions of the beams). The configuration information may, for example, indicate that there may be N^{(k)} and M^{(k)} beams in the vertical and horizontal spatial directions, respectively, for level k.

As shown in FIG. 9, N^{(k)} and M^{(k)} may be equal to 4 at level 1, equal to 8 at level 2, equal to 16 at level 3, equal to 32 at level 4, and so on. Therefore, level 1, 2, 3 and 4 may represent 4, 8, 16, and 32 beams in the vertical and horizontal spatial directions at each level. As such, let 1≤i₁^{(k)}≤N^{(k)} denote the i-th vertical beam at level k and 1≤i₂^{(k)}≤M^{(k)} denote the i-th horizontal beam at level k, a (e.g., each) reference signal or beam at that level may be indicated or identified based on indices i₁^{(k)} and i₂^{(k)} in a corresponding 2D beam image or codebook.

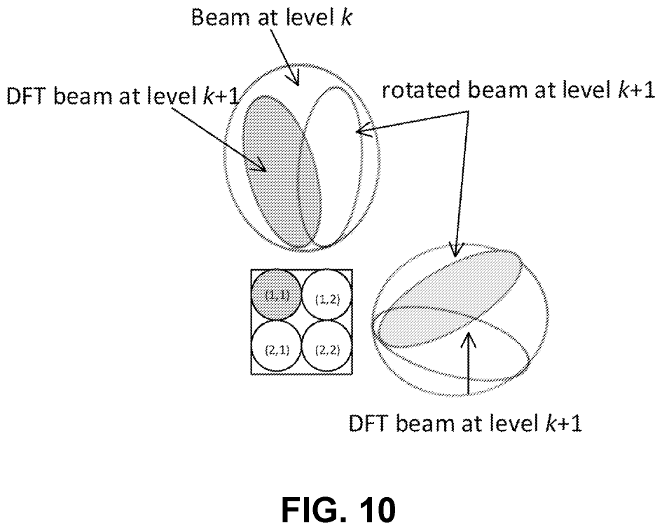

Also as shown in FIG. 9, a beam at level k (e.g., level 1) may cover the same area as the union of m sub-beams at level k+1 (e.g., level 2). The m sub-beams at the next level may be generated, for example, based on 2D DFT with rotated beams (e.g., based on a Type I codebook). FIG. 10 shows an example in which 4 sub-beams may be covered at level k+1 (e.g., each represented by (i₁^{(k+1), i}₂^{(k+1)}) sub-beams, and the combined sub-beams may cover the same area for a beam at level k. The reference signals or beams (e.g., sub-beams or narrower beams) at level k+1 may be QCL type D with a beam at level k. Such a QCL relationship (e.g., spatial relationship) between different hierarchical beam levels can be used for H-MIMO beam management to reduce the beam search effort (e.g., because once a beam at a level is identified, the sub-beams at the next level can be identified as well). For example, as shown in FIG. 18, with three levels of beams, the first level beams (e.g. 64 beams) can be specified a codebook (e.g., with 64 codewords, where one beam may be linked to a respective codeword in the codebook). Since the beams at different levels can have a QCLed relationship, the codebook associated with each level can also have a hierarchical relationship.

A WTRU may be configured (e.g., pre-configured) with a hierarchical beam structure or spatial arrangement, for example, during a beam inference training stage (e.g., to learn an AI/ML model for beam inference) for H-MIMO. The WTRU may report measurement results for one or multiple CSI-RS sets that may associated with multiple levels of beams (e.g., there may be a CSI-RS resource set for each level of beams). A configured CSI-RS resource set may include a large number of CSI-RS resources (e.g., due to the size of H-MIMO). The larger the size of a meta-surface in H-MIMO, the higher the number of CSI-RS resources that may be measured and/or reported. Beam management associated with H-MIMO may be performed utilizing the hierarchical beam structure described herein to reduce the CSI-RS resource signaling overhead.

In examples, beam management associated with H-MIMO may be performed if/when a network device is configured to conduct beam inference. One or more of the following may be performed, for example, at an initial access stage. A base station (e.g., gNB) may broadcast SSBs. The base station may transmit an SSB at a particular time within a SSB burst set. The base station may transmit an SSB index per beam with a spatial direction, or the base station may transmit multiple SSBs (e.g., with different SSB indices) on the same beam or in the same spatial direction. There may be no radio link setup before a WTRU completes a random access procedure at the initial access stage. The WTRU may measure and select a suitable beam with a certain SSB index. The WTRU may perform the random access on random access resources associated with the selected SSB index. If beam inference is enabled at the network (e.g., base station or gNB) side, the base station may configure the WTRU to report top/best q (e.g., q=4) SSBs (e.g., with the highest RSRP), along with the corresponding L1-RSRP value(s) and/or SSB index(es), during the random access procedure. An SSB may be used for beam inference because (e.g., at least partly) the SSB or an SSB burst set may be used for initial access, and the network may transmit the SSB even if not every SSB burst is transmitted (e.g., at least some SSB bursts in a SSB burst set may be transmitted at all time).

If the base station (e.g., gNB) configures (e.g., allows) the use of beam inference during the initial access stage (e.g., via system information (SI)), the WTRU may report best/top q SSBs, along with corresponding L1-RSRP value(s) and/or SSB index(es), in a PUSCH payload. In a two-step RACH procedure, the best/top q L1-RSRPs and SSB indices may be included in a PUSCH payload in step 1 (e.g., via the transmission of MsgA). In a four-step RACH procedure, the best/top q L1-RSRPs and/or SSB indices may be included in a PUSCH payload in step 3 (e.g., via the transmission of Msg3).

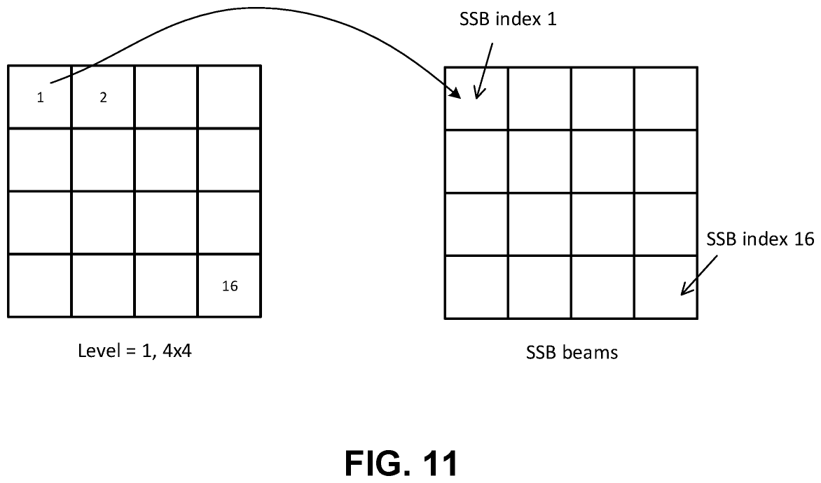

The base station may determine (e.g., depending on the RACH resources used by the WTRU) which SSB (e.g., wide beam) is selected by the WTRU, and the random-access procedure may be completed based on the determined SSB (e.g., the beam corresponding to the SSB). The base station may configure the WTRU with multiple sets of beams (e.g., arranged in a hierarchical structure) that may be associated with one or more CSI-RS resource sets (e.g., each CSI-RS source set may include multiple CSI-RS resources). The configuration information may be transmitted from the base station to the WTRU, for example, after the WTRU completes the initial access and/or enters an RRC connected state. The base station may associate a low (e.g., the lowest) level of beams (e.g., level 1) with SSBs or SSB indices, as shown in FIG. 11. This association may be done (e.g., configured), for example, via RRC signaling. A one-to-one mapping between the beams at a level and CSI-RS resources may or may not be needed. The association between a hierarchical beam structure and CSI-RS resources may be as described herein.

A network device such as a base station and/or a WTRU may be configured to perform one or more of the following, for example, in an RRC connected state. The network device (e.g., a base station, gNB or TRP) may configure the WTRU with one or multiple CSI-RS resource sets (e.g., comprising non-zero power CSI-RS resources), for example, via an information element such as CSI resourceConfig. The network device may indicate hierarchical reference signals or beams via one or more QCL type D chains, where a CSI-RS resource (e.g., corresponding to a beam) at level k+1 may be configured with a QCL type D source RS at level k. This may indicate that the beam coverage of a CSI-RS at level k+1 is within the beam coverage of a CSI-RS at level k. As such, the WTRU may use the QCL chains to trace the RS/beam hierarchy.

The network device may configured multiple non-zero power (NZP) CSI-RS resources to share the same physical time-frequency resources (e.g., the same time slot and/or port number), for example, to reduce resource overhead. The network device may perform CSI-RS beam sweeping (e.g., partial CSI-RS beam sweeping), and the WTRU may measure one or more configured NZP CSI-RS resources (e.g., based on semi-persistent CSI reporting configuration) and report measurement results (e.g., L1-RSRP with a CRI) to the network device. For example, the WTRU may perform L1-RSRP (e.g., CSI-RSRP) measurement and reporting, and the network device may use the report provided by the WTRU as an input for beam inference.

The network device may issue a CSI request, for example, in a DCI, to trigger CSI-RS reporting (e.g., aperiodic (AP) CSI-RS reporting). For example, the network device may trigger AP CSI-RS reporting on CSI-RS #1 and CSI-RS #2. AP CSI-RS #2 may be a narrow RS or beam predicted by the network device (e.g., for use by the WTRU), and AP CSI-RS #1 may be an intermediate RS or beam for the WTRU to perform hierarchical beam searching or tracking. The network device may transmit AP CSI-RS #1 (e.g., with repetition) with a medium-width beam (e.g., the beam for AP CSI-RS #1 may be a mid or lower level beam). This medium-width beam may be QCLed (e.g., via network configuration) with a wide beam (e.g., corresponding to an SSB or CSI-RS), and may be transmitted before AP CSI-RS #2 (e.g., in the slot before the transmission of CSI-RS #2). The network device may transmit AP CSI-RS #2 with a narrow beam (e.g., as a high level beam) that may be QCLed (e.g., via network configuration) with AP CSI-RS1. Based on such an arrangement or configuration, the WTRU may report CSI for CSI-RS #2 and may not report CSI for CSI-RS #1 (e.g., since CSI-RS #2 is associated with a narrower beam that is QCLed with CSI RS #1), for example, to reduce reporting overhead.

QCL assumption or linkage of reference signals or beams (e.g., hierarchical levels of reference signals or beams) may be configured, for example, to maintain an RS or beam QCL chain. Such a hierarchical structure or arrangement may implemented for H-MIMO, which may use narrow beams. One or more of the following may be implemented, for example, to reduce configuration and/or other signaling overhead.

An information element (e.g., hierarchicalBeamMapping) may be included in CSI-RS related configuration information (e.g., such as a CSI-ResourceConfig) transmitted by a network device to a WTRU. If the information element is set to ON, the WTRU may assume that CSI-RS resources in a CSI-RS/CSI SSB resource set may have a hierarchical structure, e.g., as shown in FIG. 9. For example, the WTRU may receive configuration information that indicates that CSI-RS resource set #1 is associated to the (beam) level 1 (e.g., assume CSI-RS resource set 1 is the lowest level of CSI-RS resource sets in CS/-ResourceConfig), CSI-RS resource set 2 is associated with beam level 2, and so on. This kind of configuration information may indicate the hierarchical structure of CSI-RS resource sets, e.g., for each level. If the information element (e.g., hierarchicalBeamMapping) is set to OFF, the WTRU may assume that there is no hierarchical beam structure for CSI resource/CSI resource set configuration (e.g., the WTRU can assume the configured CSI resource sets (IDs) have no hierarchical mapping among them).

The WTRU may assume that the lowest CSI resource set is associated to the lowest level of hierarchical beams and so on, until the last configured CSI resource set (e.g., when hierarchical beam mapping is ON). The WTRU may assume that the number of hierarchical RS/beam levels may be equal to the configured number of CSI resource sets in CSI-ResourceConfig. For example, SSB beams in an SSB burst set may be defaulted to the lowest level of hierarchical beams (e.g., at level 1), wherein the SSBs are the transmitted beams in the lowest level. The number of SSB beams may be determined from an information element (e.g., such as ssb-PositionsInBurst), for example, as shown in FIG. 11.

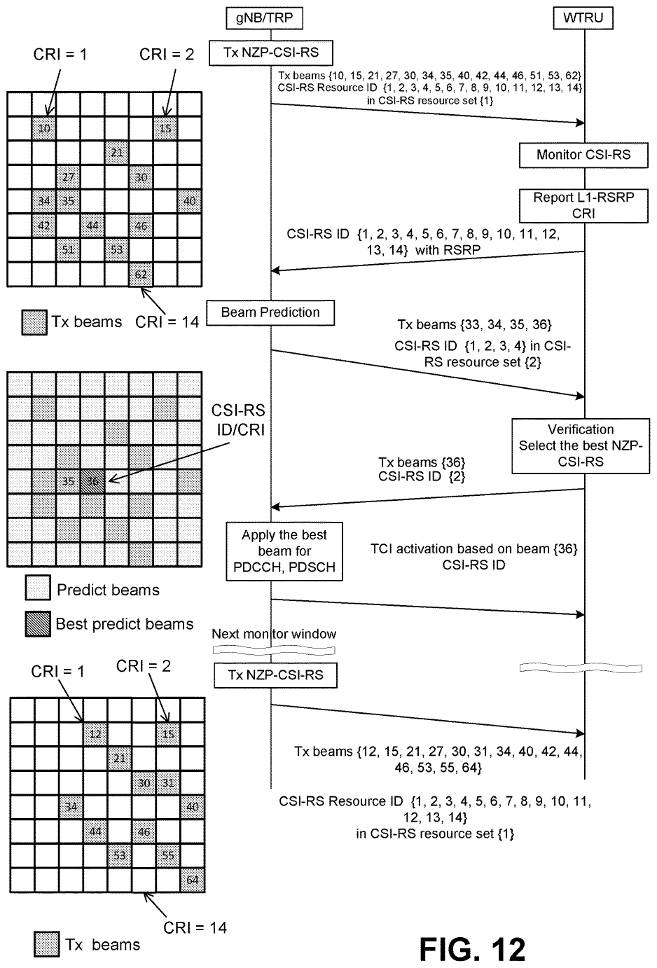

The network device (e.g., a base station or gNB) may configure the WTRU with multiple CSI resources in a (e.g., each) CSI resource set. The network device may or may not configure QCL linkage or correspondence (e.g., QCL assumptions) for the configured CSI-RS resources. The number of CSI resources in a CSI resource set may be fewer than or equal to the number of reference signals or beams at level k of a hierarchical beam structure or arrangement. A (e.g., each) CSI-RS resource in a CSI-RS resource set (e.g., CSI-RS resource set k corresponding to the (beam) level k) is QCLed type D to the next higher number CSI-RS resource set (e.g., CSI-RS resource set k+1 corresponding to beam level k+1). For example, the network device (e.g., a base station or gNB) may provide CSI configuration information (e.g., CSI-ResourceConfig) and set the number of sub-beams m (e.g., m=2^{p}, p=1,2, . . . ) to 4 (e.g., as part of the CSI configuration information) for increases at the next hierarchical level (e.g., each beam at level k may encompass 4 sub-beams at level k+1). With such a CSI resource configuration, the network device may assign m (e.g., m=4) CSI-RS resource sets, each of which may be mapped to a corresponding spatial arrangement of beams shown in FIG. 10. For instance, CSI-RS resource set #1 may be mapped to hierarchical beam level 1, CSI-RS resource set #2 may be mapped to hierarchical beam level 2, CSI-RS resource set #3 may be mapped to hierarchical beam level 3, and CSI-RS resource set #4 may be mapped to hierarchical beam level 4. In this way, the beam hierarchy may be represented via different CSI-RS resource sets configured by the network (e.g., via CSI-ResourceConfig). Additional spatial information (e.g., indicated by one or more codeword indice) may be associated to CSI-RS resource configuration. For example, a CSI-RS resource can be associated with a codeword index and a CSI-RS resource set (level) can be linked to a respective codebook, e.g., as shown in FIG. 18 and FIG. 12. A WTRU can assume this configuration is valid when hierarchicalBeamMapping is set to ON(e.g., the WTRU can assume that the additional spatial information indicated by codeword indice associated to CSI-RS resources is valid when hierarchicalBeamMapping is set to ON). The network device may (e.g., independently) configure multiple CSI-RS resources and associated spatial information (e.g., codeword IDs) in a (e.g., each) CSI-RS resource set. For example, the network device may configure 16 CSI-RS resources and their corresponding codeword IDs in CSI-RS resource set #1, 32 CSI-RS resources and their corresponding codeword IDs in CSI-RS resource set #2, etc. In examples, more (e.g., more than 32) CSI-RS resources may be configured for a higher level CSI-RS resource set, since the higher CSI-RS resource set number (e.g., hierarchy level) may correspond to a larger number of beams (e.g., beams with a finer or narrower beam width) in a spatial domain. In this way, the number of CSI-RS resources in a CSI-RS resource set for beam inference may be lower because beam inference may not use full beam sweeping. The finer/narrower beams may also lead to higher beam inference accuracy (e.g., assuming that the number of CSI-RS measurements may be sufficient for each level of beams).

The network device (e.g., a base station or gNB) may use a CSI-RS reporting period as a beam inference monitoring or validation period. This monitoring period (e.g., for beam inference) may be set by a time, the value of which may be configured by the network device. The network device may accomplish the beam inference objective based on periodic, aperiodic, or semi-persistent CSI measurement and reporting. For example, in a (e.g., each) CSI-RS reporting period, the network device may configure a WTRU with CSI configuration resources for CSI L1-RSRP reporting. In that regard, the network device may configure the WTRU with multiple CSI-RS resource sets and may associate a (e.g., each) configured CSI-RS resource set with a level of beams in a beam map. The network device may further configure the WTRU with multiple (NZP) CSI-RS resources in a (e.g., each) CSI-RS resource set for L1-RSRP measurement and reporting. As described herein, partial beam measurements may be performed based on a low to medium resolution 2D image of beams, from which the WTRU may obtain, for beam inference and/or other purposes, beam information such as spatial coverage information from one or more CSI-RS resource sets configured for measurement (e.g., if a parameter such as hierarchicalBeamMapping is set to ON in CSI-ResourceConfig).

FIG. 12 shows examples of CSI configuration information (e.g., CSI-ResourceConfig) and a beam management procedure associated with H-MIMO (e.g., in an RRC connected state). As shown in FIG. 12, a network device may configure a WTRU with multiple CSI resource sets (e.g., CSI resource set #1 and CSI resource set #2, with #1 being the lowest CSI-RS resource set ID) in a CSI resource configuration for CSI reporting (e.g., L1-RSRP reporting). A first CSI-RS resource set (e.g., CSI resource set #1) may be configured with 8 NZP CSI-RS resources for beam inference, and a second CSI-RS resource set (e.g., set #2) may be configured with 2 NZP CSI-RS resources. For beam inference, the network device may sweep a partial set of CSI-RS beams. For example, the network device may, in a beam inference monitoring period, transmit level 1 (e.g., wide, DFT-based) beams {(1,1), (1,3), (2,2), (2,4), (3,1), (3,3), (4,2), (4,4)} as shown in FIG. 12, and those level 1 beams may be mapped to the eight CSI-RS resources configured in CSI-RS resource set #1. At the beam inference stage, the WTRU may not be informed of actual beam information (e.g., DFT-based Tx beam information). A (e.g., each) CSI-RS resource in CSI-RS resource set #1 (e.g., corresponding to a level 1 beam) may be QCLed with an SSB index, and the WTRU may measure the 8 CSI-RS resources in CSI-RS resource set #1 and report the measurement results to the network device (e.g., via the PUCCH or PUSCH). The network device may predict one or more narrow or refined beams based on the measurement results (e.g., L1-RSRP) reported by the WTRU, and may inform the WTRU about the inferred or predicted beams (e.g., since the beams predicted by the network device may not be among the beams measured and reported by the WTRU using CSI-RS resource set #1). The network device may apply the inferred beam to an aperiodic CSI-RS reporting and may set the repetition flag to “ON” for NZP CSI-RS resources for a higher or the same CSI-RS resource set for the WTRU to perform CSI reporting to determine the best inferred beam and tune its receive spatial parameter(e.g., WTRU may perform Rx beamforming). The network device may also signal one or more indices of a codebook (e.g., a 2D DFT codebook) associated with the inferred beams (e.g., CSI-RS resource) to the WTRU, so that the WTRU may determine or identify the inferred beams based on the codebook. As described herein, such a codebook may be configured for the set of beams that may include the inferred beams and, as such, the codebook may provide spatial information about the beams to the WTRU. In examples, the network device may signal CSI-RS resources in a higher CSI-RS resource set to the WTRU (e.g., together with the aforementioned codebook indices) to indicate the spatial information (e.g., resolution and/or hierarchy) of the inferred beams. The WTRU may use the provided spatial information for beam pairing and may avoid performing additional beam sweeping to validate the inferred beams, thus reducing the time associated with beam searching and feedback.

The network device may configure the WTRU with aperiodic CSI-RS reporting. The network device may set a repetition flag associated with CSI-RS resource set #2 to “ON” for one or more inferred or predicted beams, as shown in FIG. 12. The network device may signal respective codebook indices associated with the inferred beams (e.g., (5,3) and (5,4) for beams 35 and 36 shown in FIG. 12) to the WTRU (e.g., via a MAC-CE or PDCCH payload), and may request (e.g., configure) aperiodic CSI-RS reporting of the inferred beams. In response, the WTRU may determine spatial information associated with the predicted beams (e.g., for Rx beam reception) based on the selected CSI-RS resource set (e.g., #2 in this example) and/or the codebook indices indicated by the network device. The WTRU may measure the beam(s) inferred and indicated by the network device, and report the measurement results (e.g., including CRI(s) associated with the measurements) back to the network device, so that the network device may determine a best beam for the WTRU. In a subsequent (e.g., the next) beam prediction or inference cycle or period, the network device may re-map a different set of beams (e.g., 2D DFT beams) such as {(1,2), (1,4), (2,1), (2,3), (3,2), (3,4), (4,1), (4,3)} to CSI-RS resource 1 to 8 in CSI-RS resource set #1. Using these techniques, beam inference may be performed based on a random or arbitrary beam pattern, or based on a fixed beam pattern. In addition, beam inference can be achieved with the proposed hierarchical beam structure and the WTRU can use the additional spatial information (e.g., codeword IDs) to identify a beam direction.

Beam inference and/or hierarchical beam searching may be supported (e.g., performed) for beam management. A network device (e.g., a base station or gNB) may configure multiple CSI-RS resource sets for a WTRU to perform measurements (e.g., L1-RSRP measurements). The network device may configure CSI reporting for a particular CSI-RS resource set such that the WTRU may report a (e.g., only one) L1-RSRP for that CSI-RS set for hierarchy beam searching. For other CSI-RS resource sets, the WTRU may report multiple L1-RSRP for beam inference.

Multi-resolution beam inference may be supported for H-MIMO. Multi-resolution beam inference may allow different beam resolutions (e.g., different sizes of squares as shown in FIG. 9) to be used as an input for beam inference. Using this approach, beam inference accuracy and super-resolution performance can be improved. A network device (e.g., a base station, gNB or TRP) may activate different CSI-RS resource sets and CSI-RS resources in each CSI-RS resource set for a WTRU to measure, and may configure the WTRU with different beam inference periods.

The WTRU may report a channel estimate (e.g., include I and Q components) per configured CSI-RS resource in a CSI-RS resource set (e.g., instead of reporting L1-RSRP per NZP CSI-RS resource). For example, the WTRU may report the channel estimation to enhance the performance of CSI reporting. A CSI reporting type may be configured for the WTRU to report measurements of a received reference signal, which may be used as an input for beam inference.

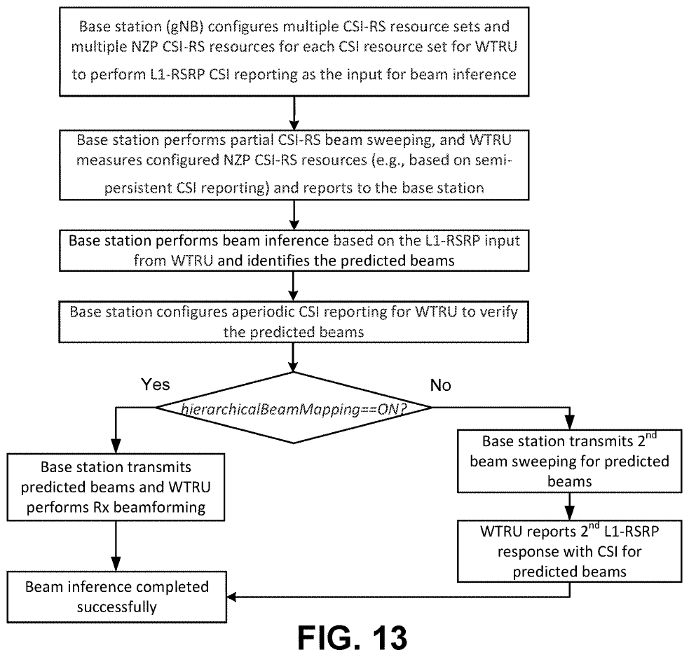

FIG. 13 illustrates an example of a beam inference procedure associated with H-MIMO (e.g., in an RRC connected state). As shown, a network device (e.g., a base station or gNB) may configure multiple CSI-RS resource sets and multiple NZP CSI-RS resources for each CSI resource set for a WTRU to perform CSI reporting (e.g., L1-RSRP CSI reporting) and the network device may use the reporting as an input for beam inference. The network device may perform partial CSI-RS beam sweeping. The WTRU may measure one or more configured NZP CSI-RS resources (e.g., based on semi-persistent CSI reporting configuration) and may report the measurement results (e.g., L1-RSRP with CRI) to the network device.

The network device may perform beam inference based on the reporting by the WTRU. The network device may configure and/or request aperiodic CSI reporting from the WTRU to verify the beam(s) inferred or predicted by the network device. In some situations (e.g., if a configuration parameter such as hierarchicalBeamMapping is set to ON), the network device may signal one or more beam indices (e.g., extra DFT beam indices) and may send a CSI-RS with a repetition flag set to ON for the WTRU to perform Rx beamforming. In some situations (e.g., if hierarchicalBeamMapping is set to OFF), the network device may perform (e.g., fall back to) beam sweeping for one or more of the predicted beam(s), and the WTRU may report measurements (e.g., L1-RSRP) associated with the swept beam(s) back to the network device. In response, the network device may perform beamforming (e.g., Rx beamforming) based on the measurements (e.g., L1-RSRP measurements) reported by the WTRU and with the repetition flag set to ON.

In examples, a WTRU may be configured to perform beam management and/or beam inference. Performing beam inference at the WTRU may reduce feedback (e.g., L1-RSRP feedback) overhead associated with one or more configured NZP CSI-RS resources and/or improve beam inference accuracy. Since a beam inferred or predicted by the WTRU may not be in a configuration list (e.g., for CSI-RS resources, TCI states, etc.), the WTRU may report the inferred beam to the network device so that the network device may determine a beams for DL transmission based on the information reported by the WTRU. The WTRU or the network device may perform one or more of the following, for example, at an initial access stage. The network device may transmit (e.g., sweep) one or more SSBs within a SSB burst set (e.g., for RSRP measurements), and the WTRU may perform beam inference based on the received SSBs, as shown in FIG. 6.

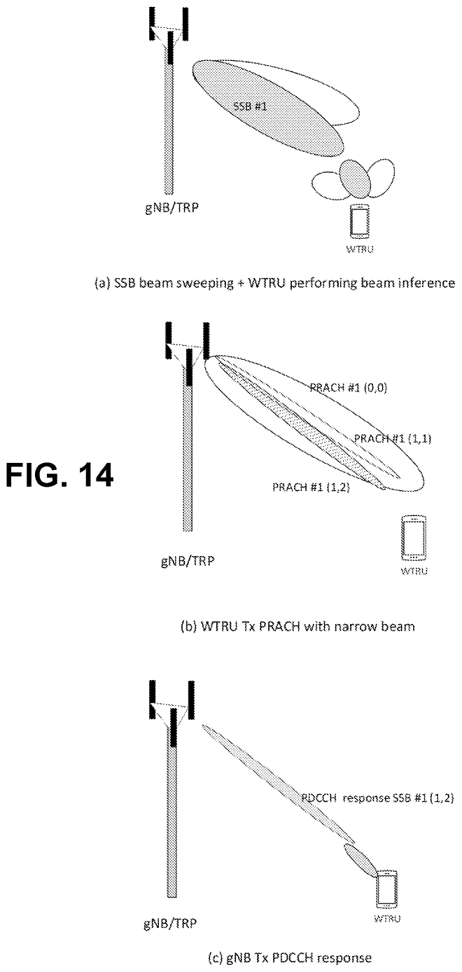

FIG. 14 shows an example of performing beam inference at a WTRU during an initial access stage. As shown, the network device may perform SSB beam (e.g., wide beam) sweeping in an SSB burst set (e.g., M SSBs transmissions within the SSB burst set may be assumed), and the WTRU may use one or more SSB RSRP measurements or received SSB signals as an input for beam inference. Based on the result of the beam inference, the WTRU may determine the best SSB (e.g., indicated by an SSB ID) or a sub-beam associated with an SSB, and select a RACH transmission occasion for performing a PRACH procedure (e.g., a two-step or four-step RACH procedure).

If a WTRU supports beam inference at the initial access stage, the network device may broadcast support information such as spatial information about beams or sub-beams, for example, as part of system information that the WTRU may receive via a broadcast channel, or using a predefined table or codebook that the WTRU may receive as part of configuration information (e.g., RRC configuration information). The network device may allocate extra RACH opportunities to support the beam inference at the WTRU.

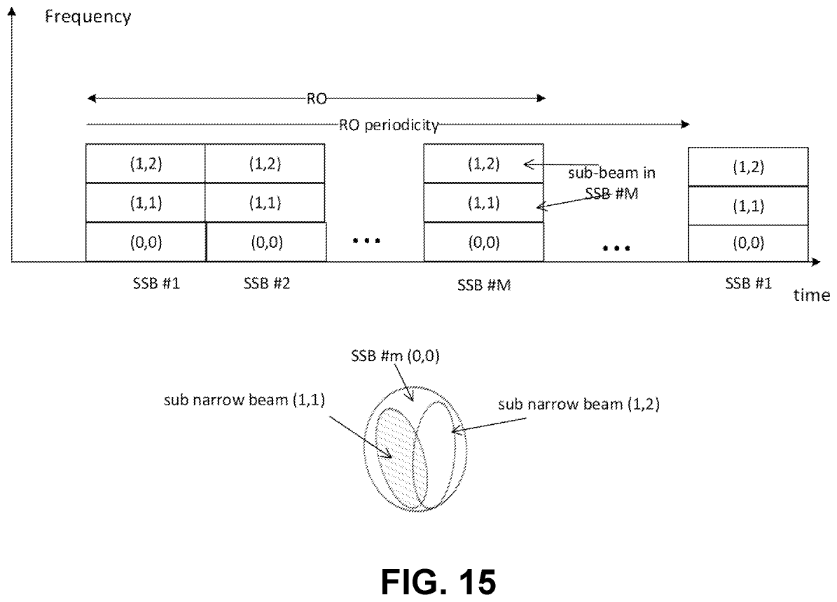

The WTRU may transmit a PRACH message in a random-access occasion (RO). The WTRU and/or the network device may determine a RACH resource based on an SSB ID, which may be obtained as a result of the beam inference at the WTRU. The PRACH transmission beam may be based on an SSB (e.g., a wide beam) or a narrow beam that may be QCLed with the SSB. The network device may allocate extra PRACH resources for sub-beam indication, as shown in (b) of FIG. 14. For example, the network device may allocate extra PRACH resources (e.g., PRACH resources (1,1) and (1,2) shown in FIG. 15) for a predicted sub-beam PRACH. The allocated PRACH resources may be multiplexed in the frequency domain with the PRACH resource for the SSB beam (e.g., PRACH resource (0,0) shown in FIG. 15).

The WTRU may use the same preamble for multiple (e.g., all) reserved PRACH resources with the same SSB ID for PRACH transmissions. For example, as shown in FIG. 15, PRACH resources (0,0), (1,1) and (1,2) for SSB ID #m may use the same PRACH preamble. A configuration parameter (e.g., such as msg1-FDM-sub, which may be set to two as shown in FIG. 15) may be used to reserve extra PRACH sub-beam resources (e.g., (1,1) and (1,2)) for SSB ID #m.

If the network device receives the PRACH successfully, the network device may use the predicted narrow beam from the WTRU to perform a PDCCH transmission, which the WTRU may monitor as a PRACH response. The WTRU may use the Tx PRACH beam spatial information as an Rx beam for reception (e.g., as shown in (c) of FIG. 14.

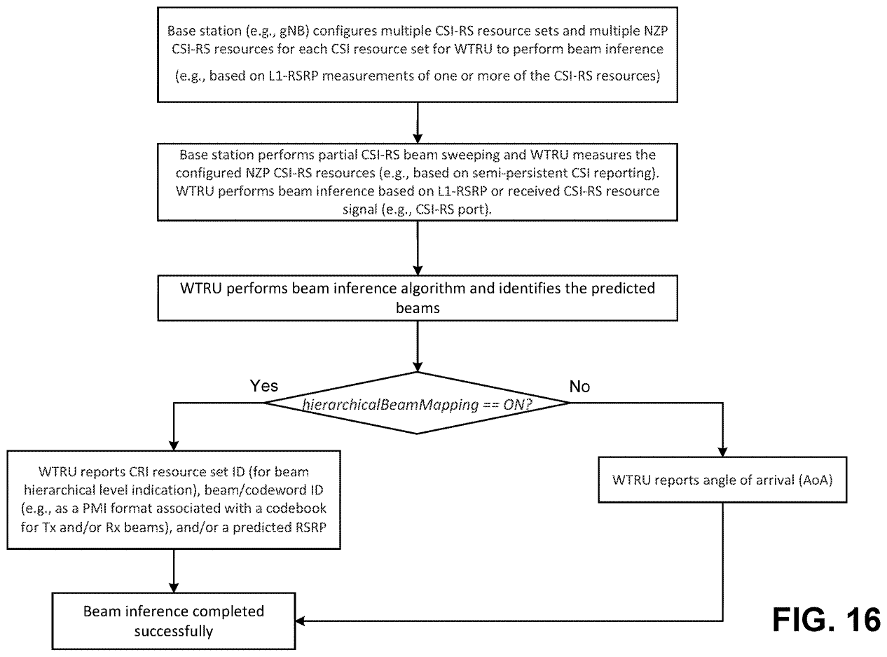

One or more of the following may be performed, e.g., in an RRC connected state. The WTRU may enter the RRC connected state, for example, after completing the initial access procedure described herein. Since beam inference may have been performed at the WTRU during the initial access stage, an inferred beam may be applied to a WTRU-specific PDCCH and/or PDSCH transmission. The network device may enhance the inferred beam (e.g., further refine the beam) or perform beam tracking. The WTRU may perform one or more of the following beam management operations in association with beam inference at the WTRU, as illustrated by FIG. 16. The network device may configure multiple CSI-RS resource sets and multiple NZP CSI-RS resources per CSI resource set for the WTRU. The network device may also perform partial CSI-RS beam sweeping and the WTRU may measure one or more of the configured NZP CSI-RS resources (e.g., based on semi-persistent CSI RS transmission and reporting). The WTRU may perform beam inference based on the measurement results (e.g., L1-RSRP values) and/or the received CSI-RS reference signals (e.g., one or more CSI-RS ports).

The WTRU may report a CSI resource set ID (e.g., as a hierarchical beam level indication), the codeword ID (e.g., via PMI format (11, 12) and/or as a beam indication), and/or the (predicted) RSRP to the network device (e.g., if hierarchicalBeamMapping is set to ON). The WTRU may report both predicted Tx and Rx beams/codeword IDs, or just Tx beam/codeword ID, or just Rx beam/codeword ID. If hierarchicalBeamMapping is set to OFF, the WTRU may report/feedback the angle of arrival (AoA) to the network device as the assistance information. The reporting of AoA may be separately configured and/or enabled, for example, independently from CSI configuration. The AoA information can be treated as the Rx beam direction reporting.

The network device may configure aperiodic CSI reporting (e.g., based on aperiodic transmissions of CSI reference signals) for the WTRU to verify one or more DL Tx beams. This may be because the DL Tx beam(s) eventually used by the network may not be same as the beams inferred or predicted by the WTRU. If a predicted reference signal or beam is under-performing (e.g., below a performance threshold), the network device may switch back to using a legacy beam management technique (e.g., based on hierarchical beam searching).

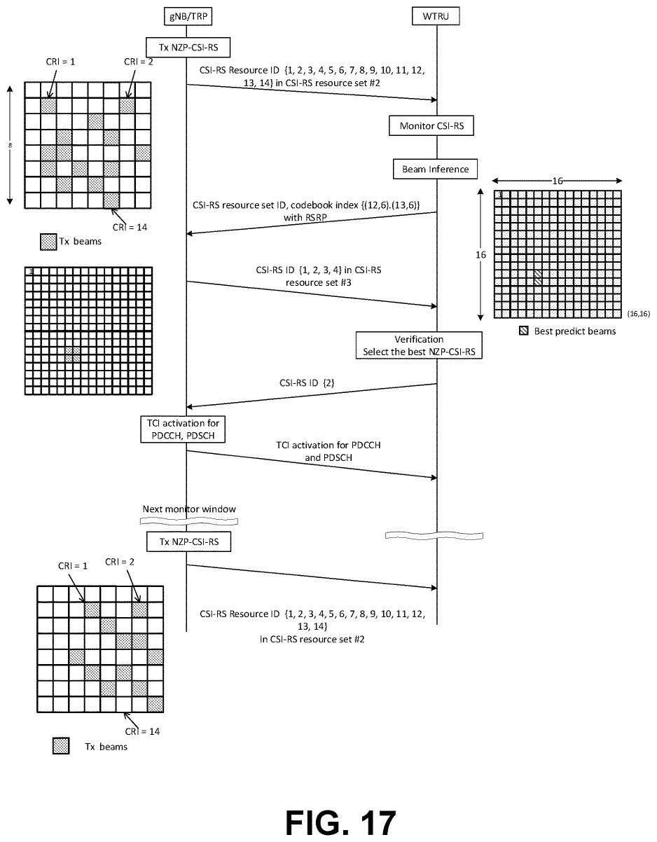

FIG. 17 shows examples of CSI resource configuration information (e.g., CSI-ResourceConfig) and beam management associated with H-MIMO when beam inference is performed at a WTRU, for example, while a WTRU is in an RRC connected state. As shown in FIG. 17, a network device such as a base station may configure multiple CSI resource sets (e.g., #2 and #3, assuming #1 is the lowest CSI-RS resource set or a CSI SSB resource set ID) in a CSI resource configuration for CSI reporting (e.g., L1-RSRP reporting). The network device may configured a first CSI-RS resource set (e.g., set #2) with 14 NZP CSI-RS resources for beam inference, and a second CSI-RS resource set (e.g., set #3) with 4 NZP CSI-RS resources for beam selection. The network device may transmit a partial set of CSI-RS beams.

For example, in a beam inference monitoring period, the network device may transmit one or more level 2(narrow) beams, e.g., based on codebook indices {(2,2), (2,7), . . . , (8,6)}. The level 2 beams may be mapped to the CSI-RS resources (e.g., 14 CSI-RS resources) in CSI-RS resource set #2. The network device may not inform the WTRU about the actual Tx (e.g., DFT) beam information. One or more (e.g., each) CSI-RS resources in the higher level CSI-RS sets may be QCLed with an SSB index for CSI-RS resource set #1 (e.g., level 1 beams). The WTRU may measure the CSI-RS resources in CSI-RS resource set #2 and may use the measurement results as input metrics for beam inference at the WTRU. The WTRU may predict one or more narrow or refined beams. In some situations (e.g., if hierarchicalBeamMapping is set to ON), the WTRU may (e.g., upon predicting the narrow or refined beams) report the CSI-RS resource set ID, predicted codeword ID (e.g., in PMI format (i₁, i₂)), and/or the measurement results (e.g., RSRP values) to the network device. The WTRU may report both predicted Tx and Rx beams/codeword IDs, or just Tx beam/codeword ID, or just Rx beam/codeword ID. The WTRU may also report RSRP (e.g., predicted RSRP) to the network device. In some situations (e.g., if hierarchicalBeamMapping is set to OFF), the WTRU may report the angle of arrival (AoA) to the network device (e.g., because there may not be GoB spatial information to which the network device may refer).

The CSI reporting may be performed via the PUCCH or PUSCH, and/or based on a reporting configuration (e.g., semi-persistent CSI reporting) of the WTRU. Since the beam(s) predicted by the WTRU may not be among the measured CSI-RS resources in a CSI-RS resource set, the WTRU may signal the predicted or inferred beams to the network device based on a grid of beams configured in a spatial domain, or via non-grid based AoA reporting to the network device (e.g., the network device may translate the AoA into spatial information). The AoA information can be treated as the Rx beam direction reporting. The network device may schedule an aperiodic CSI-RS report for the WTRU to validate a preferred beam, as shown in FIG. 17. The CSI-RS resources in a resource set (e.g., set #3) may be configured with CQI/PMI/RI to facilitate direct PDSCH transmissions.

In embodiments of the present disclosure, beam management and/or beam inference associated with H-MIMO may be performed at a network device (e.g., a base station or gNB). If a WTRU is at an initial access stage, the WTRU may report the best or top q SSBs based on measurements of the SSBs (e.g., L1-RSRP measurements), along with the measurement results (e.g., L1-RSRP of the SSBs) and/or corresponding SSB indices in a PUSCH payload (e.g., msg-B in a 2-step RACH procedure or msg 3 in a four-step RACH procedure).

If the WTRU is in an RRC connected state, the network device may configure multiple CSI-RS resource sets and multiple NZP CSI-RS resources per CSI resource set for the WTRU to perform CSI reporting (e.g., L1-RSRP CSI reporting). The reported CSI information may be used by the network device as an input for beam inference. The network device may perform partial CSI-RS beam sweeping and the WTRU may measure one or more configured NZP CSI-RS resources (e.g., based on semi-persistent CSI reporting) and report the measurement results (e.g., L1-RSRP values) and/or corresponding CRI to the network device. The network device may perform beam inference based on the measurements (e.g., L1-RSRP values) reported by the WTRU. The network device may configure an aperiodic CSI report for the WTRU to verify one or more beams inferred or predicted by the network device. In some situations (e.g., if hierarchicalBeamMapping is set to ON), the network device may signal codebook (e.g., 2D-DFT codebook) indices to the WTRU (e.g., to identify the inferred beams) and may set the repetition flag for CSI-RS to ON for the WTRU to perform Rx beamforming. In some situations (e.g., if hierarchicalBeamMapping is set to OFF), the network device may perform (e.g., fall back to) beam sweeping for the predicted beams, and the WTRU may report measurements (e.g., L1-RSRP values) of those swept beams to the network device. The network device may set the repetition flag to ON for the WTRU to perform Rx beamforming.

In embodiments of the present disclosure, beam management and/or beam inference associated with H-MIMO may be performed at a WTRU. If the WTRU is at an initial access stage, a network device (e.g., a base station or gNB) may perform SSB (e.g., wide beam) sweeping in a SSB burst set (e.g., M SSBs may be transmitted within the SSB burst set). The WTRU may select multiple SSB RSRPs (or received SSB signals) as an input for beam inference at the WTRU.

Based on the result of the beam inference, the WTRU may determine the best SSB (e.g., indicated by an SSB ID) or a sub-beam associated with an SSB. The WTRU may select a RACH transmission occasion for performing a PRACH procedure (e.g., a two-step or four-step RACH procedure). If the network device supports WTRU beam inference at the initial access stage, the network device may broadcast support information such as sub-beam spatial information as part of system information that the WTRU may receive via a broadcast channel, or using a predefined table or codebook that the WTRU may receive as part of the WTRU's configuration information. The network device may allocate extra RACH opportunities to facilitate beam inference at the WTRU.

If the network device receives the PRACH successfully, the network device may use a narrow beam (e.g., a predicted narrow beam) for a PDCCH transmission, which the WTRU may monitor as a PRACH response. The WTRU may use reported Tx PRACH beam spatial information to determine an Rx beam for reception.

With the WTRU in the RRC connected state, the network device may configure multiple CSI-RS resource sets and multiple NZP CSI-RS resources per CSI resource set for the WTRU to perform CSI measurement (e.g., L1-RSRP measurement) and/or reporting. The network device may perform partial CSI-RS beam sweeping. In response, the WTRU may measure one or more of the CSI-RS resources such as NZP CSI-RS resources configured by the network device (e.g., based on semi-persistent CSI reporting configuration), and the WTRU may perform beam inference based on the measurement results (e.g., RSRP values) and/or the received CSI-RS signals (e.g., CSI-RS ports and/or other CSI estimates associated with the CSI-RS signals). The network device may configure a type of CSI reports for the WTRU if beam inference is enabled at the WTRU side. With this type of CSI reports, the WTRU may not report measurement results such as RSRP results (e.g., L1-RSRP), and may report one or more inferred or predicted beams. The network device may configure one or more NZP CSI-RS resource sets and/or one or more CSI-RS resources per resource set for the WTRU to report the predicted beams. In some situations (e.g., if hierarchicalBeamMapping is set to ON), the WTRU may report a CSI resource set ID (e.g., for beam hierarchical level indication), a CSI-RS resource ID (e.g., for beam inference), and/or a codebook ID (e.g., in PMI format (i₁, i₂)) to the network device. In some examples, the network device may request the WTRU to report the predicted beam(s) along with the measurement results (e.g., RSRP values). In some situations (e.g., if hierarchicalBeamMapping is set to OFF), the WTRU may report an angle of arrival (AoA) to the network device. The network device may (e.g., after the network device receives feedback from the WTRU) configure an aperiodic CSI report for the WTRU to verify one or more DL Tx beams. The network device may decide to use legacy beam management (e.g., fall back to beam sweeping) even if the WTRU performs beam inference.

FIG. 18 illustrates an example of a hierarchical beam structure (e.g., hierarchical spatial arrangement of beams) that may be used in an H-MIMO system. As shown, a network device may configure a WTRU with multiple sets of beams (e.g., with respective spatial resolutions) and may indicate the sets of beams (e.g., together with their spatial arrangement) to the WTRU as part of the WTRU's configuration information (e.g., which may be sent to the WTRU via one or more RRC messages). The configuration information may, for example, indicate the number of beams included in each set of beams and the hierarchical relationship of the sets of beams (e.g., a beam associated with a lower beam level in the hierarchical arrangement may be QCLed with a beam at a higher beam level). The configuration information may include respective codebooks associated with the levels or sets of beams, and the WTRU may use the codebooks to determine the hierarchical structure or arrangement of the beams and/or to identify a specific beam (e.g., based on an index such as a codeword index associated with the codebooks).

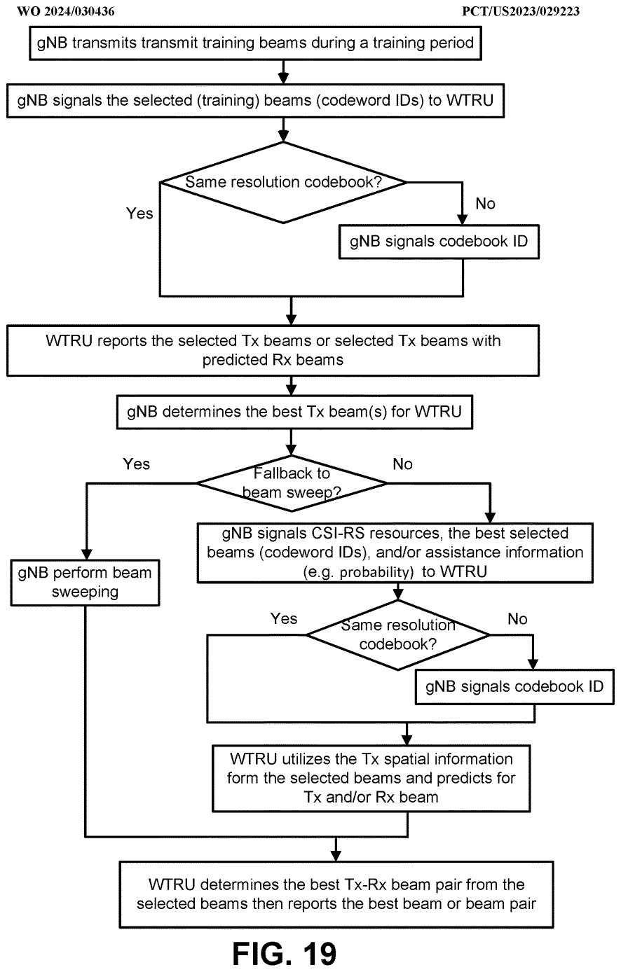

FIG. 19 illustrates example operations that may be associated with beam inference and/or beam management by a network device (e.g., a base station or gNB) and/or a WTRU. As shown in FIG. 19, the network device may transmit one or more beams to the WTRU, for example, during a training period. The network device may indicate one or more selected beams to the WTRU, for example, by indicating respective codeword identifiers (IDs) of a codebook associated with the selected beams to the WTRU. The codebook and/or the codeword IDs may have been previously indicated to the WTRU as part of the WTRU's configuration information (e.g., configuration information that may indicate a hierarchical arrangement of beams, as described herein). In examples, if the codebook is associated with the same spatial resolution (e.g., beam resolution) as a previous codebook (e.g., a codebook associated with a WTRU-predicted or WTRU-indicated beam), the network device may not signal the codebook ID again; otherwise, the network device may signal the ID of the newly selected codebook. In response to the beams and/or other indication(s) transmitted by the network device, the WTRU may measure the beams (Tx beams) and report one or more top-ranked Tx beams (e.g., along with measurement results associated with those beams) to the network device. The WTRU may also report one or more Rx beams predicted by the WTRU to the network device.

Based on the report by the WTRU, the network device may determine/select one or more beams (e.g., best Tx beams) for the WTRU. The network device further determine whether to perform (e.g., fall back to) beam sweeping for the determined beams. If the network device determines to perform the beam sweeping, the WTRU may determine a best Tx-Rx beam pair based on the swept beams and may report the determined Tx-Rx beam pair to the network device. If the network device determines not to perform the beam sweeping, the network device may indicate the beams selected by the network device and/or CSI-RS resources associated with those beams to the WTRU, together with other assistance info (e.g., codebook index, probability indicating the likelihood of the predicted beam, and/or the like). The network device may, for example, indicate the selected beams to the WTRU by indicating the respective codeword IDs associated with those beams to the WTRU. If the network device determines that the codebook associated with the selected beams has a different spatial resolution (e.g., beam resolution) from that of a previous codebook, the network device may also signal the newly selected codebook ID to the WTRU.

In response to receiving the indications of the selected beams and/or the codebook/codeword IDs, the WTRU may use spatial information associated with the selected beams (e.g., which the WTRU may have received previously via configuration information) to determine a Tx beam and/or a Rx beam for the WTRU. The WTRU may then report the determine Tx and/or Rx beams (e.g., as a Tx-Rx beam pair) to the network device.

Although features and elements described above are described in particular combinations, each feature or element may be used alone without the other features and elements of the preferred embodiments, or in various combinations with or without other features and elements.

Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

What is claimed is:

1. A wireless transmit/receive unit (WTRU), comprising:
a processor configured to:
receive configuration information from a network device, wherein the configuration information indicates a hierarchical spatial arrangement of at least a first plurality of beams and a second plurality of beams, the first plurality of beams is associated with a first spatial resolution, the second plurality of beams is associated with a second spatial resolution, and an area covered by one of the first plurality of beams encompasses an area covered by one of the second plurality of beams;
perform a measurement of a beam that belongs to the first plurality of beams or the second plurality of beams;
transmit a report regarding the measurement of the beam to the network device;
determine, based on the configuration information and a beam indication received from the network device subsequent to the transmission of the report, a transmission beam to be used by the WTRU; and
perform a transmission using the transmission beam.

2. The WTRU of claim 1, wherein the beam measured by the WTRU is one of the first plurality of beams and wherein the transmission beam is one of the second plurality of beams.

3. The WTRU of claim 1, wherein the processor is further configured to make a prediction about the transmission beam based on the configuration information received from the network device and the measurement performed by the WTRU, and to transmit an indication of the prediction to the network device.

4. The WTRU of claim 3, wherein the processor being configured to make the prediction about the transmission beam comprises the processor being configured to predict that the transmission beam to be used by the WTRU is narrower than the beam measured by the WTRU.

5. The WTRU of claim 3, wherein the processor is further configured to include the indication of the prediction in the report transmitted to the network device.

6. The WTRU of claim 1, wherein the configuration information includes a first codebook associated with the first plurality of beams and a second codebook associated with the second plurality of beams, and wherein the beam indication received from the network device includes an index that identifies the transmission beam in the first codebook or the second codebook.

7. The WTRU of claim 1, wherein the configuration information further indicates a first channel state information reference signal (CSI-RS) resource set associated with the first plurality of beams and a second CSI-RS resource set associated with the second plurality of beams, and wherein the measurement of the beam is performed using a CSI-RS resource from the first CSI-RS resource set or the second CSI-RS resource set.

8. The WTRU of claim 1, wherein the processor is further configured to predict a reception beam based at least on the configuration information received from the network device and the measurement performed by the WTRU.

9. The WTRU of claim 8, wherein the processor is further configured to include an indication of the predicted reception beam in the report that is transmitted to the network device.

10. The WTRU of claim 9, wherein the configuration information received from the network device includes a codebook associated with the first plurality of beams or the second plurality of beams, and wherein the predicted reception beam is indicated via a codeword index associated with the codebook.

11. A method implemented by a wireless transmit/receive unit (WTRU), the method comprising:
receiving configuration information from a network device, wherein the configuration information indicates a hierarchical spatial arrangement of at least a first plurality of beams and a second plurality of beams, the first plurality of beams is associated with a first spatial resolution, the second plurality of beams is associated with a second spatial resolution, and an area covered by one of the first plurality of beams encompasses an area covered by one of the second plurality of beams;
performing a measurement of a beam that belongs to the first plurality of beams or the second plurality of beams;
transmitting a report regarding the measurement of the beam to the network device;
determining, based on the configuration information and a beam indication received from the network device subsequent to the transmission of the report, a transmission beam to be used by the WTRU; and
performing a transmission using the transmission beam.

12. The method of claim 11, wherein the beam measured by the WTRU is one of the first plurality of beams and wherein the transmission beam is one of the second plurality of beams.

13. The method of claim 11, further comprising making a prediction about the transmission beam based on the configuration information received from the network device and the measurement performed by the WTRU, and indicating the prediction in the report transmitted to the network device 14. The method of claim 11, wherein the configuration information includes a first codebook associated with the first plurality of beams and a second codebook associated with the second plurality of beams, and wherein the beam indication received from the network device includes an index that identifies the transmission beam in the first codebook or the second codebook.

15. The method of claim 11, wherein the configuration information further indicates a first channel state information reference signal (CSI-RS) resource set associated with the first plurality of beams and a second CSI-RS resource set associated with the second plurality of beams, and wherein the measurement of the beam is performed using a CSI-RS resource from the first CSI-RS resource set or the second CSI-RS resource set.

16. The method of claim 11, further comprising predicting a reception beam based at least on the configuration information received from the network device, and indicating the predicted reception beam in the report transmitted to the network device.

17. A network device, comprising:
a processor configured to:
transmit configuration information to a wireless transmit/receive unit (WTRU), wherein the configuration information indicates a hierarchical spatial arrangement of at least a first plurality of beams and a second plurality of beams, the first plurality of beams is associated with a first spatial resolution, the second plurality of beams is associated with a second spatial resolution, and an area covered by one of the first plurality of beams encompasses an area covered by one of the second plurality of beams;
receive, from the WTRU, a report regarding a beam measured by the WTRU, wherein the beam belongs to the first plurality of beams or the second plurality of beams;
determine, based at least on the report, a transmission beam to be used by the WTRU; and
transmit a message to the WTRU, wherein the message indicates the transmission beam to be used by the WTRU.

18. The network device of claim 17, wherein the beam measured by the WTRU is one of the first plurality of beams and wherein the transmission beam determined by the network device is one of the second plurality of beams.

19. The network device of claim 17, the processor is configured to determine the transmission beam based further on a prediction made by the WTRU and indicated in the report.
